(19) United States
(12) Patent Application Publication
(10) Pub. No.: US 2017/0345228 A1
(43) Pub. Date: Nov. 30, 2017

(54) VEHICLE DATA EXCHANGE

(71) Applicant: NISSAN NORTH AMERICA, INC., Franklin, TN (US)

(72) Inventors: Gregory D. Dibb, Mountain View, CA (US); Siddharth Thakur, Hyderabad (IN); Daisuke Saito, Kanagawa (JP)

(21) Appl. No.: 15/166,738

(22) Filed: May 27, 2016

(51) Int. Cl. G07C 5/00; G05D 1/02; G01S 19/42

(52) U.S. Cl. CPC G07C 5/008; G01S 19/42; G05D 1/0212

(57) ABSTRACT

Vehicle data exchange may include receiving, from a subscriber device associated with a subscribing entity, a vehicle data exchange request including a vehicle sensor type identifier and vehicle data exchange request target information, wherein the vehicle data exchange request target information includes an indication of a defined geospatial region. Vehicle data exchange may include identifying, based on the vehicle data exchange request, a publishing entity, and transmitting a vehicle data exchange request execution notification to a publisher device associated with the publishing entity. Vehicle data exchange may include receiving, from the publisher device, vehicle sensor data generated by a sensor of a vehicle associated with the publishing entity within the defined geospatial region, generating a vehicle data exchange response based on the vehicle sensor data, and transmitting the vehicle data exchange response to the subscriber device.

### TECHNICAL FIELD

This disclosure relates to vehicle sensor generated data exchange.

### BACKGROUND

A vehicle may traverse a portion of a vehicle transportation network. In the course of traversing a portion of a vehicle transportation network, a sensor of the vehicle may generate or capture data. Accordingly, a system, method, and apparatus for vehicle data exchange may be advantageous.

### SUMMARY

Disclosed herein are aspects, features, elements, implementations, and embodiments of vehicle data exchange.

An aspect of the disclosed embodiments is a method for use in vehicle data exchange. Vehicle data exchange may include receiving, from a subscriber device associated with a subscribing entity, a vehicle data exchange request including a vehicle sensor type identifier and vehicle data exchange request target information, wherein the vehicle data exchange request target information includes an indication of a defined geospatial region. Vehicle data exchange may include identifying, based on the vehicle data exchange request, a publishing entity, and transmitting a vehicle data exchange request execution notification to a publisher device associated with the publishing entity. Vehicle data exchange may include receiving, from the publisher device, vehicle sensor data generated by a sensor of a vehicle associated with the publishing entity within the defined geospatial region, generating a vehicle data exchange response based on the vehicle sensor data, and transmitting the vehicle data exchange response to the subscriber device.

Another aspect of the disclosed embodiments is a method for use in vehicle data exchange. Vehicle data exchange may include transmitting, from a subscriber device associated with a subscribing entity, to a vehicle data exchange device, a vehicle data exchange request including a vehicle sensor type identifier and vehicle data exchange request target information, wherein the vehicle data exchange request target information includes an indication of a defined geospatial region. Vehicle data exchange may include receiving a vehicle data exchange response from the vehicle data exchange device. The vehicle data exchange response may include information based on vehicle sensor data generated by a sensor of a vehicle in the defined geospatial region, wherein the vehicle is associated with a publishing entity identified by the vehicle data exchange device based on the vehicle data exchange request.

Another aspect of the disclosed embodiments is a method for use in vehicle data exchange. Vehicle data exchange may include transmitting, by a publisher device associated with a publishing entity, to a vehicle data exchange device, publication policy information. Vehicle data exchange may include, on a condition that the publication policy information indicates a vehicle data exchange request discovery notification push status, receiving a vehicle data exchange request notification from the vehicle data exchange device. Vehicle data exchange may include in response to receiving the vehicle data exchange request notification, and on a condition that the publication policy information indicates a vehicle data exchange participation automation pull status, transmitting, to the vehicle data exchange device, a vehicle data exchange request participation message. Vehicle data exchange may include in response to transmitting the vehicle data exchange request participation message or on the condition that the publication policy information indicates the vehicle data exchange participation automation pull status, receiving, by the publisher device, from the vehicle data exchange device, a vehicle data exchange request execution notification based on a vehicle data exchange request, the vehicle data exchange request received by the vehicle data exchange device from a subscriber device associated with a subscribing entity, the vehicle data exchange request including a vehicle sensor type identifier and vehicle data exchange request target information, wherein the vehicle sensor type identifier corresponds with a sensor of a vehicle associated with the publishing entity, and wherein the vehicle data exchange request target information includes an indication of a defined geospatial region. Vehicle data exchange may include traversing, by the vehicle, a portion of a vehicle transportation network, wherein traversing includes generating vehicle sensor data by the vehicle sensor within the defined geospatial region, and transmitting, to the vehicle data exchange device, the vehicle sensor data.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The various aspects of the methods and apparatuses disclosed herein will become more apparent by referring to the examples provided in the following description and drawings in which:

FIG. 1 is a diagram of an example of a vehicle in which the aspects, features, and elements disclosed herein may be implemented;

FIG. 2 is a diagram of an example of a portion of a vehicle transportation and communication system in which the aspects, features, and elements disclosed herein may be implemented;

FIG. 3 is a diagram of an example of creating a vehicle data exchange request in accordance with embodiments of this disclosure;

FIG. 4 is a diagram of an example of pull request discovery in accordance with embodiments of this disclosure;

FIG. 5 is a diagram of an example of vehicle data exchange request participation messaging in accordance with embodiments of this disclosure;

FIG. 6 is a diagram of an example of vehicle data exchange request execution in accordance with embodiments of this disclosure;

FIG. 7 is a diagram of an example of sensor data processing in accordance with embodiments of this disclosure;

FIG. 8 is a diagram of an example of completing a vehicle data exchange request in accordance with embodiments of this disclosure;

FIG. 9 is a diagram of an example of vehicle data exchange request discovery by itinerary in accordance with embodiments of this disclosure;

FIG. 10 is a diagram of an example of vehicle data exchange driving operation reporting in accordance with embodiments of this disclosure; and

FIG. 11 is a diagram of an example of vehicle data exchange request discovery by reported operation in accordance with embodiments of this disclosure.

### DETAILED DESCRIPTION

A vehicle, such as a vehicle traversing a portion of a vehicle transportation network, a vehicle operating outside of a vehicle transportation network, or any other vehicle, may include one or more sensors that may generate or capture sensor data in the course operation. The sensor data may be useful to third parties. However, mechanisms for providing access to the sensor data to interested third parties may be unavailable or inefficient.

In some embodiments, a vehicle, or an owner or operator of the vehicle, may opt-in to publish vehicle sensor data to a vehicle data exchange. A publisher of vehicle sensor data may control the data that is published, and how the data is used by the vehicle data exchange, by providing a publication profile. A publication profile may, for example, indicate a level of privacy for the published vehicle sensor data, may indicate whether the publisher receives push notifications, or may indicate whether the publisher automatically participates in relevant publication activities.

In some embodiments, interested third parties may subscribe to and receive published vehicle sensor data from the vehicle data exchange. Subscribers may submit requests for data from the vehicle data exchange. Requests may indicate metrics for identifying publishers or published data, such a geospatial location information indicating a geospatial location or region corresponding to the generation or capture of the sensor data.

In some embodiments, the vehicle data exchange may identify publishers to provide data responsive to a request for vehicle sensor data. The vehicle data exchange may generate processed data by identifying and removing erroneous data, or aggregating the published sensor data. The vehicle data exchange may generate projected data based on analysis of the source vehicle sensor data or the processed data. The vehicle data exchange may provide source vehicle sensor data, processed data, projected data, or a combination thereof to subscribers. The vehicle data exchange may receive payment from the subscribers and may provide compensation to the publishers.

As used herein, the terminology “computer” or “computing device” includes any unit, or combination of units, capable of performing any method, or any portion or portions thereof, disclosed herein.

As used herein, the terminology “processor” indicates one or more processors, such as one or more special purpose processors, one or more digital signal processors, one or more microprocessors, one or more controllers, one or more microcontrollers, one or more application processors, one or more Application Specific Integrated Circuits, one or more Application Specific Standard Products; one or more Field Programmable Gate Arrays, any other type or combination of integrated circuits, one or more state machines, or any combination thereof.

As used herein, the terminology “memory” indicates any computer-usable or computer-readable medium or device that can tangibly contain, store, communicate, or transport any signal or information that may be used by or in connection with any processor. For example, a memory may be one or more read only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. In some embodiments, instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the terminology “example”, “embodiment”, “implementation”, “aspect”, “feature”, or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

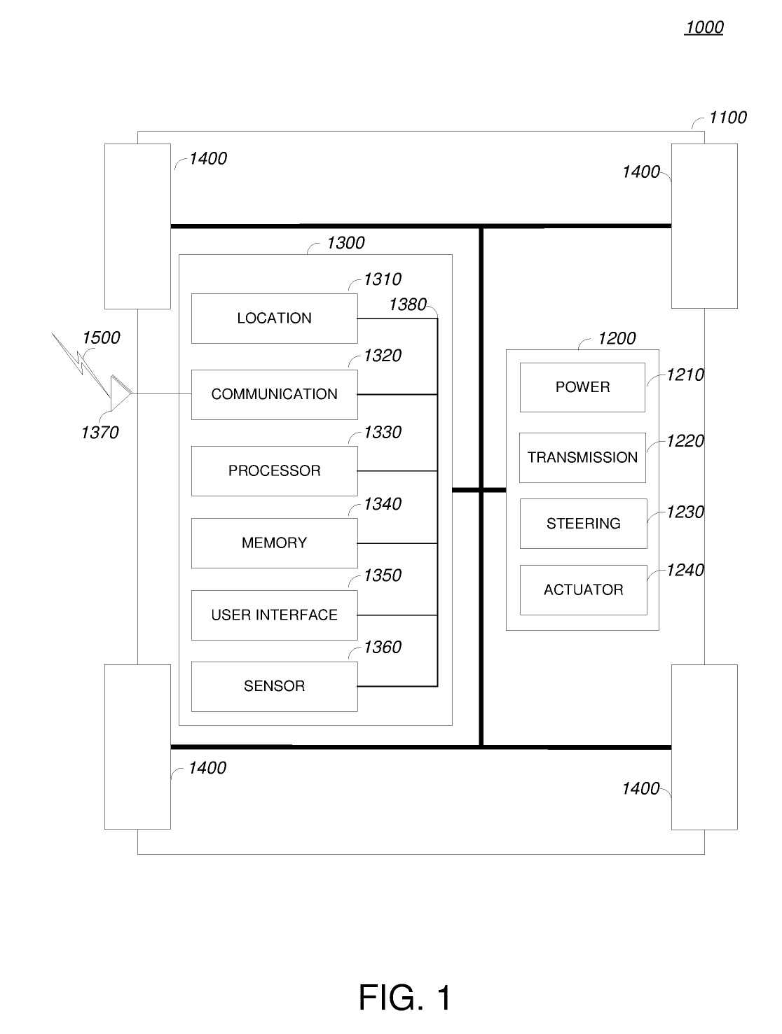

FIG. 1 is a diagram of an example of a vehicle in which the aspects, features, and elements disclosed herein may be implemented. In some embodiments, a vehicle 1000 may include a chassis 1100, a powertrain 1200, a controller 1300, wheels 1400, or any other element or combination of elements of a vehicle. Although the vehicle 1000 is shown as including four wheels 1400 for simplicity, any other propulsion device or devices, such as a propeller or tread, may be used. In FIG. 1, the lines interconnecting elements, such as the powertrain 1200, the controller 1300, and the wheels 1400, indicate that information, such as data or control signals, power, such as electrical power or torque, or both information and power, may be communicated between the respective elements. For example, the controller 1300 may receive power from the powertrain 1200 and may communicate with the powertrain 1200, the wheels 1400, or both, to control the vehicle 1000, which may include accelerating, decelerating, steering, or otherwise controlling the vehicle 1000.

The powertrain 1200 may include a power source 1210, a transmission 1220, a steering unit 1230, an actuator 1240, or any other element or combination of elements of a powertrain, such as a suspension, a drive shaft, axles, or an exhaust system. Although shown separately, the wheels 1400 may be included in the powertrain 1200.

The power source 1210 may include an engine, a battery, or a combination thereof. The power source 1210 may be any device or combination of devices operative to provide energy, such as electrical energy, thermal energy, or kinetic energy. For example, the power source 1210 may include an engine, such as an internal combustion engine, an electric motor, or a combination of an internal combustion engine and an electric motor, and may be operative to provide kinetic energy as a motive force to one or more of the wheels 1400. In some embodiments, the power source 1210 may include a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 1220 may receive energy, such as kinetic energy, from the power source 1210, and may transmit the energy to the wheels 1400 to provide a motive force. The transmission 1220 may be controlled by the controller 1300 the actuator 1240 or both. The steering unit 1230 may be controlled by the controller 1300 the actuator 1240 or both and may control the wheels 1400 to steer the vehicle. The vehicle actuator 1240 may receive signals from the controller 1300 and may actuate or control the power source 1210, the transmission 1220, the steering unit 1230, or any combination thereof to operate the vehicle 1000.

In some embodiments, the controller 1300 may include a location unit 1310, an electronic communication unit 1320, a processor 1330, a memory 1340, a user interface 1350, a sensor 1360, an electronic communication interface 1370, or any combination thereof. Although shown as a single unit, any one or more elements of the controller 1300 may be integrated into any number of separate physical units. For example, the user interface 1350 and processor 1330 may be integrated in a first physical unit and the memory 1340 may be integrated in a second physical unit. Although not shown in FIG. 1, the controller 1300 may include a power source, such as a battery. Although shown as separate elements, the location unit 1310, the electronic communication unit 1320, the processor 1330, the memory 1340, the user interface 1350, the sensor 1360, the electronic communication interface 1370, or any combination thereof may be integrated in one or more electronic units, circuits, or chips.

In some embodiments, the processor 1330 may include any device or combination of devices capable of manipulating or processing a signal or other information now-existing or hereafter developed, including optical processors, quantum processors, molecular processors, or a combination thereof. For example, the processor 1330 may include one or more special purpose processors, one or more digital signal processors, one or more microprocessors, one or more controllers, one or more microcontrollers, one or more integrated circuits, one or more an Application Specific Integrated Circuits, one or more Field Programmable Gate Array, one or more programmable logic arrays, one or more programmable logic controllers, one or more state machines, or any combination thereof. The processor 1330 may be operatively coupled with the location unit 1310, the memory 1340, the electronic communication interface 1370, the electronic communication unit 1320, the user interface 1350, the sensor 1360, the powertrain 1200, or any combination thereof. For example, the processor may be operatively coupled with the memory 1340 via a communication bus 1380.

The memory 1340 may include any tangible non-transitory computer-usable or computer-readable medium, capable of, for example, containing, storing, communicating, or transporting machine readable instructions, or any information associated therewith, for use by or in connection with the processor 1330. The memory 1340 may be, for example, one or more solid state drives, one or more memory cards, one or more removable media, one or more read only memories, one or more random access memories, one or more disks, including a hard disk, a floppy disk, an optical disk, a magnetic or optical card, or any type of non-transitory media suitable for storing electronic information, or any combination thereof.

The communication interface 1370 may be a wireless antenna, as shown, a wired communication port, an optical communication port, or any other wired or wireless unit capable of interfacing with a wired or wireless electronic communication medium 1500. Although FIG. 1 shows the communication interface 1370 communicating via a single communication link, a communication interface may be configured to communicate via multiple communication links. Although FIG. 1 shows a single communication interface 1370, a vehicle may include any number of communication interfaces.

The communication unit 1320 may be configured to transmit or receive signals via a wired or wireless medium 1500, such as via the communication interface 1370. Although not explicitly shown in FIG. 1, the communication unit 1320 may be configured to transmit, receive, or both via any wired or wireless communication medium, such as radio frequency (RF), ultra violet (UV), visible light, fiber optic, wire line, or a combination thereof. Although FIG. 1 shows a single communication unit 1320 and a single communication interface 1370, any number of communication units and any number of communication interfaces may be used. In some embodiments, the communication unit 1320 may include a dedicated short range communications (DSRC) unit, an on-board unit (OBU), or a combination thereof.

The location unit 1310 may determine geolocation information, such as longitude, latitude, elevation, direction of travel, or speed, of the vehicle 1000. For example, the location unit may include a global positioning system (GPS) unit, such as a Wide Area Augmentation System (WAAS) enabled National Marine -Electronics Association (NMEA) unit, a radio triangulation unit, or a combination thereof. The location unit 1310 can be used to obtain information that represents, for example, a current heading of the vehicle 1000, a current position of the vehicle 1000 in two or three dimensions, a current angular orientation of the vehicle 1000, or a combination thereof.

The user interface 1350 may include any unit capable of interfacing with a person, such as a virtual or physical keypad, a touchpad, a display, a touch display, a heads-up display, a virtual display, an augmented reality display, a haptic display, a feature tracking device, such as an eye-tracking device, a speaker, a microphone, a video camera, a sensor, a printer, or any combination thereof. The user interface 1350 may be operatively coupled with the processor 1330, as shown, or with any other element of the controller 1300. Although shown as a single unit, the user interface 1350 may include one or more physical units. For example, the user interface 1350 may include an audio interface for performing audio communication with a person, and a touch display for performing visual and touch based communication with the person. In some embodiments, the user interface 1350 may include multiple displays, such as multiple physically separate units, multiple defined portions within a single physical unit, or a combination thereof.

The sensor 1360 may include one or more sensors, such as an array of sensors, which may be operable to provide information that may be used to control the vehicle. The sensors 1360 may provide information regarding current operating characteristics of the vehicle. The sensors 1360 can include, for example, a speed sensor, acceleration sensors, a steering angle sensor, traction-related sensors, braking-related sensors, steering wheel position sensors, eye tracking sensors, seating position sensors, or any sensor, or combination of sensors, that is operable to report information regarding some aspect of the current dynamic situation of the vehicle 1000.

In some embodiments, the sensors 1360 may include sensors that are operable to obtain information regarding the physical environment surrounding the vehicle 1000. For example, one or more sensors may detect road geometry and obstacles, such as fixed obstacles, vehicles, and pedestrians. In some embodiments, the sensors 1360 can be or include one or more video cameras, laser-sensing systems, infrared-sensing systems, acoustic-sensing systems, or any other suitable type of on-vehicle environmental sensing device, or combination of devices, now known or later developed. In some embodiments, the sensors 1360 and the location unit 1310 may be combined.

Although not shown separately, in some embodiments, the vehicle 1000 may include a trajectory controller. For example, the controller 1300 may include the trajectory controller. The trajectory controller may be operable to obtain information describing a current state of the vehicle 1000 and a route planned for the vehicle 1000, and, based on this information, to determine and optimize a trajectory for the vehicle 1000. In some embodiments, the trajectory controller may output signals operable to control the vehicle 1000 such that the vehicle 1000 follows the trajectory that is determined by the trajectory controller. For example, the output of the trajectory controller can be an optimized trajectory that may be supplied to the powertrain 1200, the wheels 1400, or both. In some embodiments, the optimized trajectory can be control inputs such as a set of steering angles, with each steering angle corresponding to a point in time or a position. In some embodiments, the optimized trajectory can be one or more paths, lines, curves, or a combination thereof.

One or more of the wheels 1400 may be a steered wheel, which may be pivoted to a steering angle under control of the steering unit 1230, a propelled wheel, which may be torqued to propel the vehicle 1000 under control of the transmission 1220, or a steered and propelled wheel that may steer and propel the vehicle 1000.

Although not shown in FIG. 1, a vehicle may include units, or elements not shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

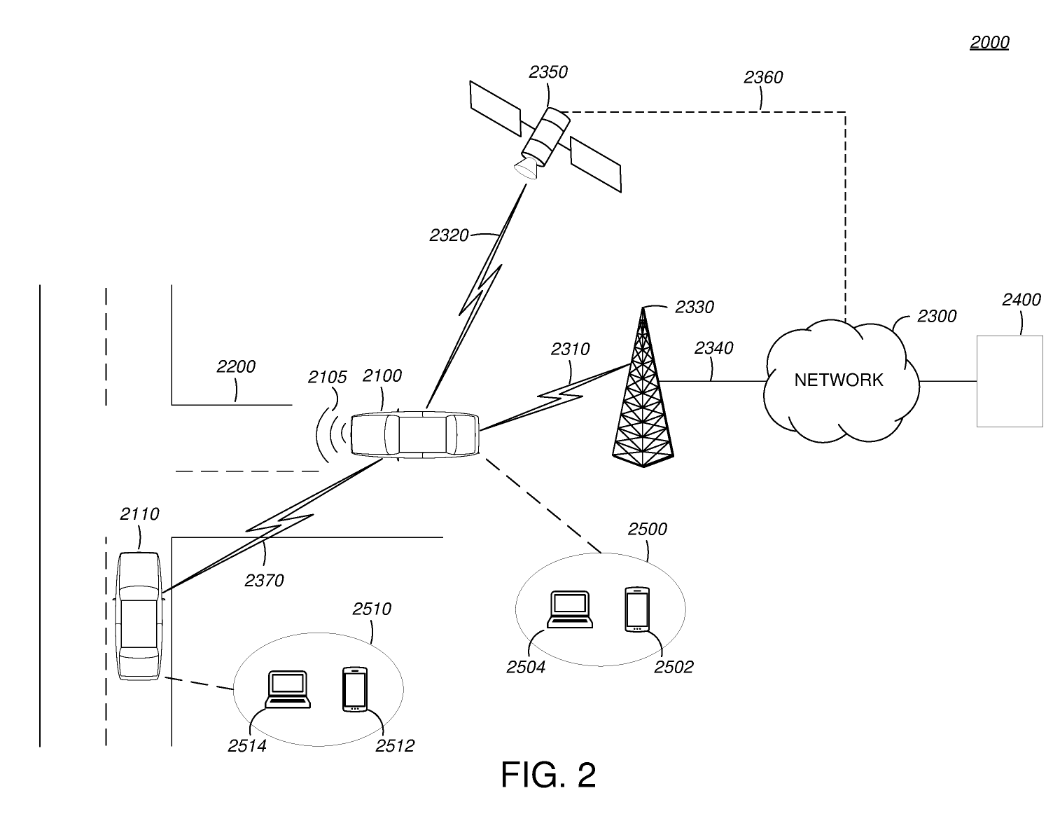

FIG. 2 is a diagram of an example of a portion of a vehicle transportation and communication system in which the aspects, features, and elements disclosed herein may be implemented. The vehicle transportation and communication system 2000 may include one or more vehicles 2100/2110, such as the vehicle 1000 shown in FIG. 1, which may travel via one or more portions of one or more vehicle transportation networks 2200, and may communicate via one or more electronic communication networks 2300. Although not explicitly shown in FIG. 2, a vehicle may traverse an area that is not expressly or completely included in a vehicle transportation network, such as an off-road area.

In some embodiments, the electronic communication network 2300 may be, for example, a multiple access system and may provide for communication, such as voice communication, data communication, video communication, messaging communication, or a combination thereof, between the vehicle 2100/2110 and one or more communication devices 2400. For example, a vehicle 2100/2110 may receive information, such as information representing the vehicle transportation network 2200, from a communication device 2400 via the network 2300.

In some embodiments, a vehicle 2100/2110 may communicate via a wired communication link (not shown), a wireless communication link 2310/2320/2370, or a combination of any number of wired or wireless communication links. For example, as shown, a vehicle 2100/2110 may communicate via a terrestrial wireless communication link 2310, via a non-terrestrial wireless communication link 2320, or via a combination thereof. In some implementations, a terrestrial wireless communication link 2310 may include an Ethernet link, a serial link, a Bluetooth link, an infrared (IR) link, an ultraviolet (UV) link, or any link capable of providing for electronic communication.

In some embodiments, a vehicle 2100/2110 may communicate with another vehicle 2100/2110. For example, a host, or subject, vehicle (HV) 2100 may receive one or more automated inter-vehicle messages, such as a basic safety message (BSM), from a remote, or target, vehicle (RV) 2110, via a direct communication link 2370, or via a network 2300. For example, the remote vehicle 2110 may broadcast the message to host vehicles within a defined broadcast range, such as 300 meters. In some embodiments, the host vehicle 2100 may receive a message via a third party, such as a signal repeater (not shown), another remote vehicle (not shown), or any other intermediary or third party. In some embodiments, a vehicle 2100/2110 may transmit one or more automated inter-vehicle messages periodically, based on, for example, a defined interval, such as 100 milliseconds.

Automated inter-vehicle messages may include vehicle identification information, geospatial state information, such as longitude, latitude, or elevation information, geospatial location accuracy information, kinematic state information, such as vehicle acceleration information, yaw rate information, speed information, vehicle heading information, braking system status information, throttle information, steering wheel angle information, or vehicle routing information, or vehicle operating state information, such as vehicle size information, headlight state information, turn signal information, wiper status information, transmission information, or any other information, or combination of information, relevant to the transmitting vehicle state. For example, transmission state information may indicate whether the transmission of the transmitting vehicle is in a neutral state, a parked state, a forward state, or a reverse state.

In some embodiments, the vehicle 2100 may communicate with the communications network 2300 via an access point 2330. An access point 2330, which may include a computing device, may be configured to communicate with a vehicle 2100, with a communication network 2300, with one or more communication devices 2400, or with a combination thereof via wired or wireless communication links 2310/2340. For example, an access point 2330 may be a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit, an access point may include any number of interconnected elements.

In some embodiments, the vehicle 2100 may communicate with the communications network 2300 via a satellite 2350, or other non-terrestrial communication device. A satellite 2350, which may include a computing device, may be configured to communicate with a vehicle 2100, with a communication network 2300, with one or more communication devices 2400, or with a combination thereof via one or more communication links 2320/2360. Although shown as a single unit, a satellite may include any number of interconnected elements.

An electronic communication network 2300 may be any type of network configured to provide for voice, data, or any other type of electronic communication. For example, the electronic communication network 2300 may include a local area network (LAN), a wide area network (WAN), a virtual private network (VPN), a mobile or cellular telephone network, the Internet, or any other electronic communication system. The electronic communication network 2300 may use a communication protocol, such as the transmission control protocol (TCP), the user datagram protocol (UDP), the internet protocol (IP), the real-time transport protocol (RTP) the Hyper Text Transport Protocol (HTTP), or a combination thereof. Although shown as a single unit, an electronic communication network may include any number of interconnected elements.

In some embodiments, a vehicle 2100 may identify a portion or condition of the vehicle transportation network 2200. For example, the vehicle may include one or more on-vehicle sensors 2105, such as sensor 1360 shown in FIG. 1, which may include a speed sensor, a wheel speed sensor, a camera, a gyroscope, an optical sensor, a laser sensor, a radar sensor, a sonic sensor, or any other sensor or device or combination thereof capable of determining or identifying a portion or condition of the vehicle transportation network 2200.

In some embodiments, a vehicle 2100 may traverse a portion or portions of one or more vehicle transportation networks 2200 using information communicated via the network 2300, such as information representing the vehicle transportation network 2200, information identified by one or more on-vehicle sensors 2105, or a combination thereof.

Although, for simplicity, FIG. 2 shows one vehicle 2100, one vehicle transportation network 2200, one electronic communication network 2300, and one communication device 2400, any number of vehicles, networks, or computing devices may be used. In some embodiments, the vehicle transportation and communication system 2000 may include devices, units, or elements not shown in FIG. 2. Although the vehicle 2100 is shown as a single unit, a vehicle may include any number of interconnected elements.

Although the vehicle 2100 is shown communicating with the communication device 2400 via the network 2300, the vehicle 2100 may communicate with the communication device 2400 via any number of direct or indirect communication links. For example, the vehicle 2100 may communicate with the communication device 2400 via a direct communication link, such as a Bluetooth communication link.

In some embodiments, a vehicle 2100/2210 may be associated with an entity 2500/2510, such as a driver, operator, or owner of the vehicle. In some embodiments, an entity 2500/2510 associated with a vehicle 2100/2110 may be associated with one or more personal electronic devices 2502/2504/2512/2514, such as a smartphone 2502/2512 or a computer 2504/2514. In some embodiments, a personal electronic device 2502/2504/2512/2514 may communicate with a corresponding vehicle 2100/2110 via a direct or indirect communication link. Although one entity 2500/2510 is shown as associated with one vehicle 2100/2110 in FIG. 2, any number of vehicles may be associated with an entity and any number of entities may be associated with a vehicle.

Although not shown separately in FIG. 2, in some embodiments, the communication device 2400 may be a vehicle data exchange device. Although referred to as a vehicle data exchange device herein, a vehicle data exchange device may include one or more servers, or other computing devices, implementing vehicle data exchange portions of the methods disclosed herein.

In some embodiments, a vehicle data exchange device may implement one or more services, such as web services, or interfaces, such as application programming interfaces, for vehicle data exchange. In some embodiments, the vehicle data exchange device may implement, operate, or provide a notification service for transmitting notifications, such as push notifications, to one or more external devices, such as the vehicles 2100/2110, or the personal electronic devices 2502/2504/2512/2514. In some embodiments, the vehicle data exchange device may implement, operate, or provide an application programming interface service, such as a RESTful application programming interface service, for communicating with one or more external devices, such as the vehicles 2100/2110, or the personal electronic devices 2502/2504/2512/2514. In some embodiments, the vehicle data exchange device may implement, operate, or provide a data upload service for receiving reported information from one or more external devices, such as the vehicles 2100/2110, or the personal electronic devices 2502/2504/2512/2514.

In some embodiments, the vehicle data exchange device 2400 may implement, operate, or maintain one or more data storage units, such as databases, or database tables within a database. In some embodiments, the vehicle data exchange device 2400 may implement, operate, or maintain an entity settings data storage unit, a publication policy data storage unit, a vehicle data exchange request data storage unit, a vehicle operation data storage unit, a sensor information data storage unit, a processed requests data storage unit, or a combination thereof.

In some embodiments, one or more of the entities 2500/2510 may be a publishing entity, a subscribing entity, or both. A publishing entity may publish or transmit vehicle data exchange information, such as vehicle sensor data, to the vehicle data exchange device 2400. For example, a vehicle 2100/2110 may be associated with a publishing entity 2500/2510, may include a communication unit, such as the communication unit 1320 shown in FIG. 1, and may transmit, or publish, vehicle data exchange information, such as vehicle sensor data generated by a sensor of the vehicle 2100/2110, such as the sensor 1360 shown in FIG. 1, to the vehicle data exchange device 2400. A subscribing entity may generate vehicle data exchange requests, may transmit the vehicle data exchange requests to the vehicle data exchange device 2400, and may receive vehicle data exchange result information from the vehicle data exchange device 2400.

In some embodiments, a vehicle 2100/2110 may be associated with a publishing entity 2500/2510, may transmit vehicle data exchange information to one or more of the personal electronic devices 2502/2504/2512/2514 associated with the respective publishing entity 2500/2510, and the personal electronic devices 2502/2504/2512/2514 may publish the vehicle data exchange information, or a portion thereof, to the vehicle data exchange device 2400.

In some embodiments, a vehicle 2100/2110 may be associated with a publishing entity 2500/2510, one or more of the personal electronic devices 2502/2504/2512/2514 associated with the respective publishing entity 2500/2510 may transmit vehicle data exchange information to the vehicle 2100/2110, and the vehicle 2100/2110 may publish the vehicle data exchange information, or a portion thereof, to the vehicle data exchange device 2400.

Although not shown separately in FIG. 2, in some embodiments, one or more of the personal electronic devices 2502/2504/2512/2514 may communicate with the vehicle data exchange device 2400, such as via the network 2300. For example, one or more of the personal electronic devices 2502/2504/2512/2514 may publish personal electronic device sensor data to the vehicle data exchange device 2400.

In some embodiments, one or more of the personal electronic devices 2502/2504/2512/2514, the vehicles 2100/2110, or a combination thereof may transmit publication policy information for a publishing entity 2500/2510 to the vehicle data exchange device 2400. For example, a vehicle 2100/2110 may transmit publication policy information for a publishing entity 2500/2510, such as a driver or owner of the vehicle 2100/2110, to the vehicle data exchange device 2400, in response to input, such as user input, from the publishing entity.

In some embodiments, publication policy information may indicate one or more publication policy metrics for the respective publishing entity 2500/2510, for a vehicle 2100/2110 associated with the respective publishing entity 2500/2510, for a personal electronic device associated with the respective publishing entity 2500/2510, or a combination thereof.

In some embodiments, publication policy information may include available sensor information, such as a list of sensors, which may include vehicle sensor type identifiers. A vehicle sensor type identifier may indicate a type of vehicle sensor, such as the sensor 1360 shown in FIG. 1, which may be a vehicle speed sensor, a vehicle temperature sensor, a camera, a GPS sensor, a parking sensor, or any other vehicle sensor. In some embodiments, a vehicle 2100/2110 may include one or more sensors that may be omitted from the sensor information, or may be identified as unavailable in the sensor information. For example, a speed sensor of a vehicle 2100/2110 may be identified by an available vehicle sensor identifier. In another example, a video sensor of a personal electronic device 2502/2504/2512/2514, may be identified by an unavailable personal electronic device sensor identifier.

In some embodiments, publication policy information may include vehicle data exchange privacy information associated with a publishing entity 2500/2510, a personal electronic devices 2502/2504/2512/2514 associated with a publishing entity 2500/2510, a vehicle 2100/2110 associated with a publishing entity 2500/2510, or a combination thereof. In some embodiments, the vehicle data exchange privacy information may indicate whether unmasked information, which may uniquely identify the publishing entity 2500/2510, a personal electronic devices 2502/2504/2512/2514 associated with the publishing entity, the vehicle 2100/2110, or a combination thereof, may be included or used for vehicle data exchange.

In some embodiments, the vehicle data exchange privacy information may indicate whether masked information, which may uniquely and anonymously identify the publishing entity 2500/2510, a personal electronic devices 2502/2504/2512/2514 associated with the publishing entity, the vehicle 2100/2110, or a combination thereof, may be included or used for vehicle data exchange. In some embodiments, the masked data may indicate a proxy or placeholder identifier representing the publishing entity 2500/2510, a personal electronic devices 2502/2504/2512/2514 associated with the publishing entity, the vehicle 2100/2110, or a combination thereof, and may omit information expressly identifying the publishing entity 2500/2510, a personal electronic devices 2502/2504/2512/2514 associated with the publishing entity, the vehicle 2100/2110, or a combination thereof.

In some embodiments, the vehicle data exchange privacy information may indicate whether anonymous information, which may omit information uniquely identifying the publishing entity 2500/2510, a personal electronic devices 2502/2504/2512/2514 associated with the publishing entity, the vehicle 2100/2110, or a combination thereof, may be included or used for vehicle data exchange.

In some embodiments, publication policy information may include vehicle data exchange participation incentive information associated with a publishing entity 2500/2510, a personal electronic devices 2502/2504/2512/2514 associated with a publishing entity 2500/2510, a vehicle 2100/2110 associated with a publishing entity 2500/2510, or a combination thereof. The vehicle data exchange participation incentive information may indicate a minimum acceptable incentive for the use of data published by the publishing entity 2500/2510, or a vehicle 2100/2110, or a personal electronic device 2502/2504/2512/2514 associated with the publishing entity. In some embodiments, the vehicle data exchange participation incentive information may indicate a range of acceptable incentives.

In some embodiments, publication policy information may include vehicle data exchange request discovery notification information associated with a publishing entity 2500/2510, a personal electronic devices 2502/2504/2512/2514 associated with a publishing entity 2500/2510, a vehicle 2100/2110 associated with a publishing entity 2500/2510, or a combination thereof. In some embodiments, the vehicle data exchange request discovery notification information may indicate a notification push status or a notification pull status for a publishing entity 2500/2510, a personal electronic devices 2502/2504/2512/2514 associated with a publishing entity 2500/2510, a vehicle 2100/2110 associated with a publishing entity 2500/2510, or a combination thereof. A notification push status may indicate that the vehicle data exchange device 2400 may push, or automatically transmit, vehicle data exchange request discovery notifications to the respective publishing entity 2500/2510, personal electronic device 2502/2504/2512/2514, vehicle 2100/2110, or combination thereof. A notification pull status may indicate that the vehicle data exchange device 2400 may omit pushing, or automatically transmitting, vehicle data exchange request discovery notifications to the respective publishing entity 2500/2510, personal electronic device 2502/2504/2512/2514, vehicle 2100/2110, or combination thereof, and may transmit vehicle data exchange request discovery notifications to the respective publishing entity 2500/2510, personal electronic device 2502/2504/2512/2514, vehicle 2100/2110, or combination thereof, in response to receiving an express, or pull, vehicle data exchange request discovery message from the respective publishing entity 2500/2510, personal electronic device 2502/2504/2512/2514, vehicle 2100/2110, or combination thereof.

In some embodiments, publication policy information may include vehicle data exchange participation automation information associated with a publishing entity 2500/2510, a personal electronic devices 2502/2504/2512/2514 associated with a publishing entity 2500/2510, a vehicle 2100/2110 associated with a publishing entity 2500/2510, or a combination thereof. In some embodiments, the vehicle data exchange participation automation information may indicate a participation push status or a participation pull status for a publishing entity 2500/2510, a personal electronic devices 2502/2504/2512/2514 associated with a publishing entity 2500/2510, a vehicle 2100/2110 associated with a publishing entity 2500/2510, or a combination thereof. A participation push status may indicate that the vehicle data exchange device 2400 may push, or automatically include, a respective publishing entity 2500/2510, personal electronic device 2502/2504/2512/2514, vehicle 2100/2110, or combination thereof, as a push participation publishing entity for appropriate vehicle data exchange requests. A participation pull status may indicate that the vehicle data exchange device 2400 may omit pushing, or automatically including, the respective publishing entity 2500/2510, personal electronic device 2502/2504/2512/2514, vehicle 2100/2110, or combination thereof, as a push participation publishing entity for appropriate vehicle data exchange requests, and may identify the respective publishing entity 2500/2510, personal electronic device 2502/2504/2512/2514, vehicle 2100/2110, or combination thereof, as a pull participation publishing entity.

In some embodiments, publication policy information may include vehicle data exchange operation publication information, which may indicate whether operation information may be published to the vehicle data exchange independently of an identified vehicle data exchange request, for a respective publishing entity 2500/2510, personal electronic device 2502/2504/2512/2514, vehicle 2100/2110, or combination thereof.

In some embodiments, publication policy information may include vehicle data exchange publication mode information, which may indicate whether sensor information may be published to the vehicle data exchange independently of an identified vehicle data exchange request, for a respective publishing entity 2500/2510, personal electronic device 2502/2504/2512/2514, vehicle 2100/2110, or combination thereof.

In some embodiments, publication policy information may include temporal metrics, geospatial metrics, or a combination thereof. A temporal metric may indicate a defined temporal location, such as a date and time, a defined temporal range, such as from a beginning date to an end date, or a defined temporal period, such as one or more days of the week, one or more days of the month, one or more time ranges within one or more days of the week or one or more days of the month. For example, a defined temporal period may indicate 6:00 a.m. to 9:00 a.m., Monday, Wednesday, and Friday. A geospatial metric may indicate a geospatial region, which may include a portion of a vehicle transportation network. In some embodiments, temporal metrics, geospatial metrics, or both, may be associated with the publication policy. For example, a temporal metric associated with a publication policy may indicate that the opt-in publication policy applies for a defined temporal range identified by the temporal metric. In some embodiments, a geospatial metric, a temporal metric, or a combination thereof may be associated with one or more of the publication policy metrics. For example, a geospatial metric associated with a vehicle sensor identifier or a vehicle sensor type identifier may indicate that vehicle sensor data captured by the corresponding vehicle sensor within a geospatial region identified by the geospatial metric may be published, and vehicle sensor data captured by the corresponding vehicle sensor outside the geospatial region identified by the geospatial metric may be omitted from publishing, or may be otherwise omitted from the vehicle data exchange data.

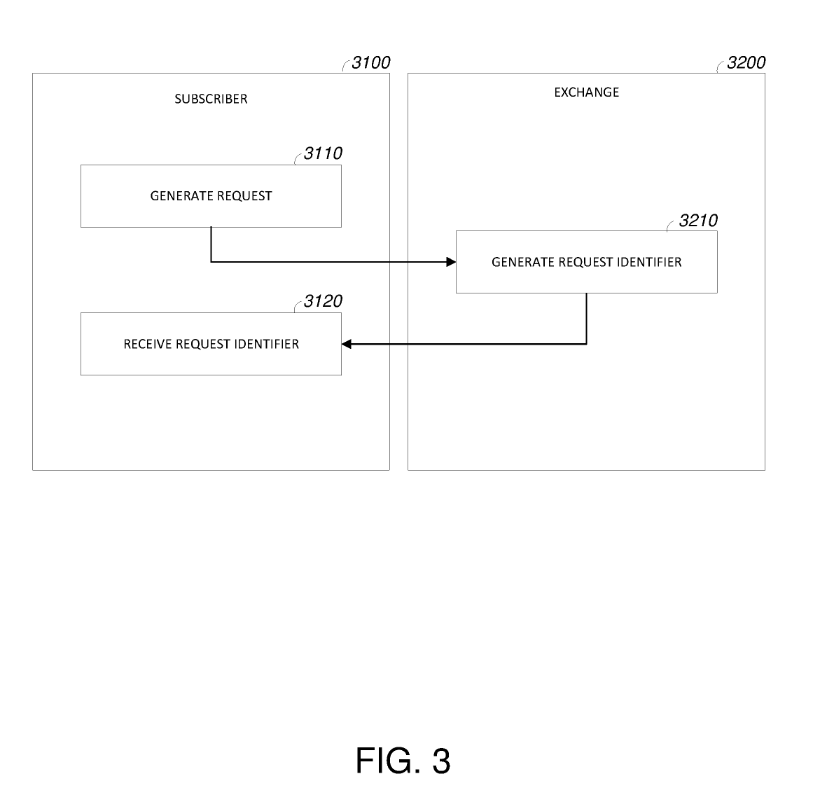

FIG. 3 is a diagram of an example of creating a vehicle data exchange request in accordance with embodiments of this disclosure. In some embodiments, a vehicle data exchange request may include a request for data from a vehicle data exchange. For example, a subscriber may send a vehicle data exchange request to a vehicle data exchange to request, or subscribe to, vehicle data exchange data. In some embodiments, creating a vehicle data exchange request may include exchanging one or more communications between a subscriber device 3100, such as a vehicle, associated with a subscribing entity, such as a driver of the vehicle, and a vehicle data exchange device 3200.

In some embodiments, subscriber portions 3110/3120 of creating a vehicle data exchange request may be implemented in subscriber device 3100, which may be a vehicle, such as the vehicle 1000 shown in FIG. 1, or one of the vehicles 2100/2110 shown in FIG. 2. In some embodiments, subscriber portions 3110/3120 of creating a vehicle data exchange request may be implemented in a personal electronic device, such as a smartphone, associated with a driver of the vehicle. In some embodiments, exchange portions 3210 of creating a vehicle data exchange request may be implemented in a vehicle data exchange device 3200, which may be a communication device, such as the communication device 2400 shown in FIG. 2, and which may include one or more servers.

In some embodiments, creating a vehicle data exchange request may include generating a vehicle data exchange request at 3110. In some embodiments, generating a vehicle data exchange request may include identifying vehicle data exchange request information. For example, the subscriber device 3100 may identify the vehicle data exchange request information. In some embodiments, identifying vehicle data exchange request information may include identifying one or more parameters or metrics describing the vehicle data exchange request.

In some embodiments, identifying vehicle data exchange request information may include identifying one or more vehicle sensor type identifiers. A vehicle sensor type identifier may indicate a type of vehicle sensor, such as the sensor 1360 shown in FIG. 1, which may be a vehicle speed sensor, a vehicle temperature sensor, a camera, a GPS sensor, or any other vehicle sensor. In some embodiments, a vehicle data exchange request including a vehicle sensor type identifier may be a request for information generated based on the identified vehicle sensor type. For example, a vehicle data exchange request including a vehicle speed sensor type identifier may be a request for vehicle speed information.

In some embodiments, identifying vehicle data exchange request information may include identifying a data state identifier. In some embodiments, the data state identifier may indicate a target, or requested, data state, such as a source data state, a processed data state, or a projected data state, for vehicle data exchange response information generated in response to the vehicle data exchange request.

In some embodiments, a source data state may indicate data as captured by the vehicle sensor. For example, vehicle data exchange information captured by a vehicle speed sensor and having a source data state may include a temporal location, such as a date and time the sensor captured, generated, or record the data, a geospatial location, such as GPS coordinates associated with the sensor capturing, generating, or recording the data, and a vehicle speed indicating a speed of the vehicle as captured, generated, or recorded by the vehicle sensor. In some embodiments, source data state vehicle data exchange information may include data from one or more vehicles.

In some embodiments, a processed data state may indicate information that is based on source data state information from one or more sensors of one or more vehicles and has been validated, corrected, aggregated, or otherwise processed. For example, vehicle data exchange information captured by a vehicle speed sensor and having a processed data state may include a temporal range, such as a time period, an identifier of a portion of a vehicle transportation network, such as a lane identifier, an average, or mean, vehicle speed corresponding to the identified portion of the vehicle transportation network and the identified temporal range, or a combination thereof.

In some embodiments, a projected data state may indicate information that projected, assessed, extrapolated, or otherwise generated based on source data state information from one or more sensors of one or more vehicles, which may have been validated, corrected, aggregated, or otherwise processed. For example, vehicle data exchange information having a projected data state may include a temporal range, such as a time period, an identifier of a portion of a vehicle transportation network, such as a lane identifier, status or availability information for the identified portion of the vehicle transportation network and the identified temporal range, or a combination thereof. In an example, the projected data may indicate that a lane of the vehicle transportation network is closed based on processed data indicating an average speed for the lane below a minimum threshold, or open based on processed data indicating an average speed for the lane above the minimum threshold.

In some embodiments, identifying vehicle data exchange request information may include identifying a data providence metric. In some embodiments, the data providence metric may indicate a target, or requested, providence, or level of anonymity, for vehicle data exchange response information generated in response to the vehicle data exchange request, such as an anonymous providence, a masked providence, or an unmasked providence. The data providence metric may correspond with vehicle data exchange privacy information indicated in publication policy information.

In some embodiments, the data providence metric may indicate an unmasked data providence, which may indicate that vehicle data exchange response information generated in response to the vehicle data exchange request may include information uniquely identifying the publisher device or publishing entity that generated the corresponding source data.

In some embodiments, the data providence metric may indicate a masked data providence, which may indicate that vehicle data exchange response information generated in response to the vehicle data exchange request may include information uniquely and anonymously identifying the publisher device or publishing entity that generated the corresponding source data. In some embodiments, the masked data may indicate a proxy or placeholder representing the publisher device or publishing entity that generated the corresponding source data, and may omit information expressly identifying the publisher device or publishing entity that generated the corresponding source data.

In some embodiments, the data providence metric may indicate an anonymous data providence, which may indicate that vehicle data exchange response information generated in response to the vehicle data exchange request may omit information uniquely identifying the publisher device or publishing entity that generated the corresponding source data.

In some embodiments, identifying vehicle data exchange request information may include identifying an incentive indication. In some embodiments, the incentive indication may indicate a type of incentive for vehicle data exchange response information generated in response to the vehicle data exchange request, such as a fixed incentive.

In some embodiments, identifying vehicle data exchange request information may include identifying vehicle data exchange request target information. In some embodiments, the vehicle data exchange request target information may indicate a target, or requested, geospatial location, such as a defined geospatial region, a target, or requested, temporal location, such as a defined temporal region, or both, for vehicle data exchange response information generated in response to the vehicle data exchange request. The target geospatial location may indicate a geospatial location or region corresponding to capturing or generating the source data for responding to the vehicle data exchange request. In some embodiments, the target geospatial location information may indicate GPS coordinates, or a vehicle transportation network address. In some embodiments, the target geospatial location information may indicate a range corresponding to a distance from a target geospatial location, such as a geospatial area centered on GPS coordinates, or a vehicle transportation network address. The target temporal location may indicate one or more temporal locations or regions, such as a range of dates, times, or date and times, corresponding to capturing or generating the source data for responding to the vehicle data exchange request.

In some embodiments, identifying vehicle data exchange request information may include identifying a recurrence metric for the vehicle data exchange request. In some embodiments, the recurrence metric may be associated with the temporal information, and may indicate whether the vehicle data exchange request may be executed repeatedly. For example, the temporal target information may indicate a temporal period including weekdays, Monday, Tuesday, Wednesday, Thursday, and Friday, and the recurrence metric may indicate that a vehicle data exchange response for the vehicle data exchange request may be generated each week for the identified temporal period. In some embodiments, the recurrence metric may indicate a cardinality or count of repetitions.

In some embodiments, identifying vehicle data exchange request information may include identifying a target cardinality, or count, of participating publishers for a vehicle data exchange request. In some embodiments, the target cardinality of participating publishers may indicate a maximum, a minimum, or a maximum and a minimum, number of publishing entities, or publishing devices, for which published vehicle sensor data may be included in a vehicle data exchange response for the vehicle data exchange request.

In some embodiments, generating the vehicle data exchange request at 3110 may include generating a communication or message including the vehicle data exchange request metrics. For example, a subscriber device 3100, which may be a subscriber vehicle or a personal electronic device operated by a subscribing entity, may generate the vehicle data exchange request message. In some embodiments, the subscriber device 3100 may store the vehicle data exchange request information in a memory of the subscriber device 3100.

In some embodiments, generating the vehicle data exchange request at 3110 may include transmitting the vehicle data exchange request. For example, a subscriber device 3100 may transmit the vehicle data exchange request to a vehicle data exchange device 3200, such as the communication device 2400 shown in FIG. 2, via a network, such as the network 2300 shown in FIG. 2.

In some embodiments, creating a vehicle data exchange request may include generating a request identifier for the vehicle data exchange request at 3210. For example, a vehicle data exchange device 3200 may receive the vehicle data exchange request from the subscriber device 3100 and may generate a request identifier at 3220 in response to receiving a vehicle data exchange request. In some embodiments, the vehicle data exchange device 3200 may store the vehicle data exchange request information, the request identifier, or both, in a memory of the vehicle data exchange device 3200. In some embodiments, the vehicle data exchange device 3200 may transmit the request identifier generated to the subscriber device 3100. In some embodiments, the vehicle data exchange device 3200 may identify a vehicle data exchange request status of received for the vehicle data exchange request in response to receiving the vehicle data exchange request. In some embodiments, the vehicle data exchange device 3200 may identify a vehicle data exchange request status of pending for the vehicle data exchange request in response to transmitting the request identifier to the subscriber device 3100.

In some embodiments, creating a vehicle data exchange request may include receiving the request identifier at the subscriber device 3100 at 3120. In some embodiments, the subscriber device 3100 may store the vehicle data exchange request identifier in a memory of the subscriber device 3100. For example, the vehicle data exchange request identifier may be stored in association with the vehicle data exchange request.

In some embodiments, a vehicle data exchange request, or a portion thereof, may be generated in response to input, such as user input, from a subscribing entity. For example, a display device of a vehicle or a personal electronic device associated with a subscribing entity may present information representing a portion of a vehicle transportation network, such as a map, and a target geospatial location or region for the vehicle data exchange request may be identified in response to input, such as user input, selecting a portion of the representation of the vehicle transportation network. In some embodiments, the representation of the vehicle transportation network may include information indicating one or more available sensors, or corresponding vehicles, geospatially located in the portion of the vehicle transportation network shown, the input may indicate an identified vehicle or sensor, and the corresponding vehicle data exchange request may include an identification of the identified vehicle or sensor.

As an example, in response to a vehicle data exchange request indicating an identified vehicle, a vehicle data exchange response may include available vehicle sensor data corresponding to then identified vehicle.

In some embodiments, the representation of the vehicle transportation network, or a portion thereof, may be divided into sub-portions, regions, or cells, such as in a grid pattern, which may be hierarchical. In some embodiments, geo-hashing may be used to partition the vehicle transportation network or corresponding GPS coordinates.

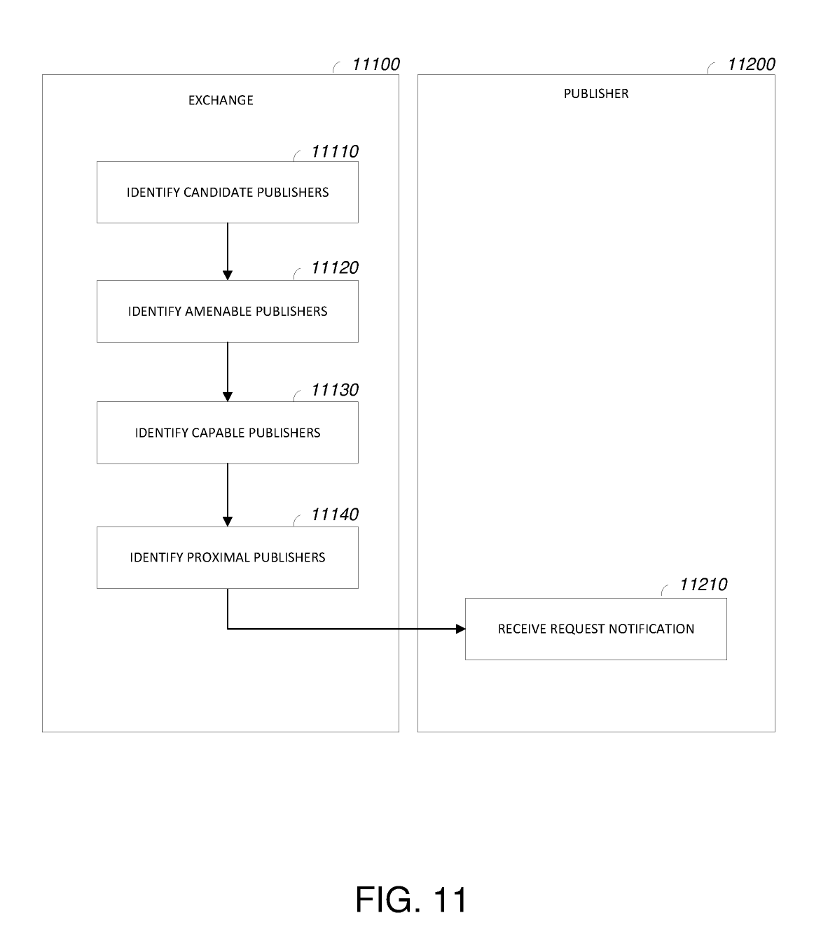

In some embodiments, vehicle data exchange request discovery by reported operation, as shown in FIG. 11, may be performed by the vehicle data exchange device 3200 in response to creating a vehicle data exchange request.

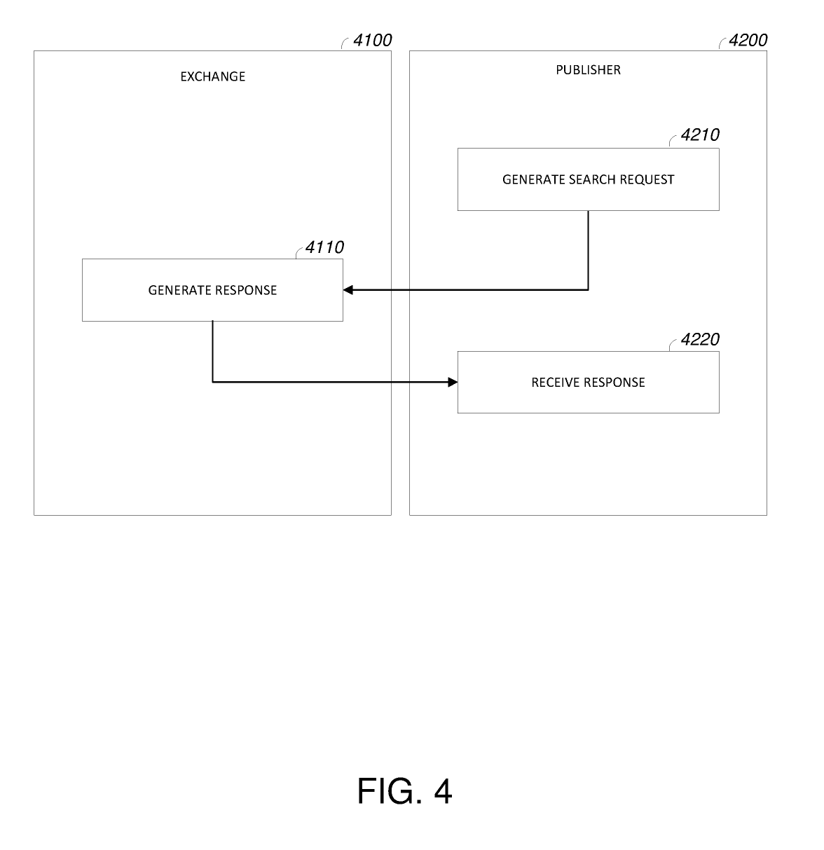

FIG. 4 is a diagram of an example of pull request discovery in accordance with embodiments of this disclosure. In some embodiments, pull request discovery may include identifying vehicle data exchange requests in response to an express or explicit request from a publishing device 4200 to identify vehicle data exchange requests. For example, a publisher, or publishing device 4200, may send a vehicle data exchange request discovery message to a vehicle data exchange device 4100. In some embodiments, pull request discovery may include exchanging one or more communications between a vehicle data exchange device 4100, such as a server, and a publisher device 4200, such as a vehicle, associated with a publishing entity, such as a driver, operator, or owner of the vehicle, or a personal electronic device associated with the publishing entity.

In some embodiments, exchange portions 4110 of pull request discovery may be implemented in a vehicle data exchange device 4100, which may be a communication device, such as the communication device 2400 shown in FIG. 2, and which may include one or more servers. In some embodiments, publisher portions 4210/4220 of pull request discovery may be implemented in a publisher device 4200, which may be a vehicle, such as the vehicle 1000 shown in FIG. 1, or one of the vehicles 2100/2110 shown in FIG. 2, a personal electronic device, such as a smartphone, associated with the publishing entity, or a combination of a vehicle and a personal electronic device.

In some embodiments, pull request discovery may include generating a vehicle data exchange request discovery message at 4210. In some embodiments, generating a vehicle data exchange request discovery message may include identifying vehicle data exchange request discovery information. For example, the publisher device 4200 may identify the vehicle data exchange request discovery information. In some embodiments, identifying vehicle data exchange request discovery information may include identifying one or more parameters or metrics describing the vehicle data exchange request discovery request.

In some embodiments, identifying vehicle data exchange request discovery information may include identifying one or more vehicle sensor type identifiers, a data state identifier, a data providence metric, an incentive indication, vehicle data exchange request target information, or a combination thereof. For example, the vehicle sensor type identifiers may indicate one or more sensor of the publisher vehicle and may correspond with a sensor type identifier indicated by one or more vehicle data exchange requests. In another example, a data state identifier may correspond with a data state identifier indicated by one or more vehicle data exchange requests. In another example, a data providence metric may correspond with a data providence metric indicated by one or more vehicle data exchange requests. In another example, an incentive indication may correspond with an incentive indication indicated by one or more vehicle data exchange requests. In another example, vehicle data exchange request target information may correspond with vehicle data exchange request target information indicated by one or more vehicle data exchange requests.

In some embodiments, the publisher device 4200 may include the vehicle data exchange request discovery information in a vehicle data exchange request discovery message and may transmit the vehicle data exchange request discovery message to a vehicle data exchange device 4100, such as the communication device 2400 shown in FIG. 2, via a network, such as the network 2300 shown in FIG. 2. In some embodiments, the publisher device 4200 may store the vehicle data exchange request discovery identifier in a memory of the publisher device 4200.

In some embodiments, the vehicle data exchange device 4100 may receive the vehicle data exchange request discovery message and may generate a vehicle data exchange request discovery response at 4110. In some embodiments, generating the vehicle data exchange request discovery response may include searching or filtering one or more vehicle data exchange requests to identify vehicle data exchange requests corresponding with the vehicle data exchange request discovery information and omitting one or more vehicle data exchange requests not corresponding with the vehicle data exchange request discovery information. For example, the vehicle data exchange request discovery information may include a speed sensor type identifier, a first vehicle data exchange request may indicate a speed sensor type identifier, a second vehicle data exchange request may omit an indication of a speed sensor type identifier, an identifier of the first vehicle data exchange request may be included in the vehicle data exchange request discovery response generated at 4110 and the second vehicle data exchange request may be omitted from the vehicle data exchange request discovery response. In some embodiments, generating the vehicle data exchange request discovery response may include identifying vehicle data exchange requests having a request status of received, pending, or executing, and omitting vehicle data exchange requests having a request status of reported, processed, or completed.

In some embodiments, the vehicle data exchange device 4100 may transmit the vehicle data exchange request discovery response to the publisher device 4200 via a network, such as the network 2300 shown in FIG. 2.

In some embodiments, the vehicle data exchange device 4100 may store the vehicle data exchange request discovery response information in a memory of the vehicle data exchange device 4100. In some embodiments, the vehicle data exchange device 4100 may store a vehicle data exchange request status of notified for the vehicle data exchange request in association with an identifier of the publisher device 4200 or publishing entity.

In some embodiments, the publisher device 4200 may receive the vehicle data exchange request discovery response from the vehicle data exchange device 4100, via the network, at 4220. In some embodiments, the publisher device 4200 may store the vehicle data exchange request discovery response information in a memory of the publisher device 4200. In some embodiments, the publisher device 4200 may present the vehicle data exchange request discovery response, or information included therein, to the publishing entity. For example, the vehicle data exchange request discovery response may include two vehicle data exchange requests, and presenting the vehicle data exchange request discovery response may include presenting an indication of each of the vehicle data exchange requests.

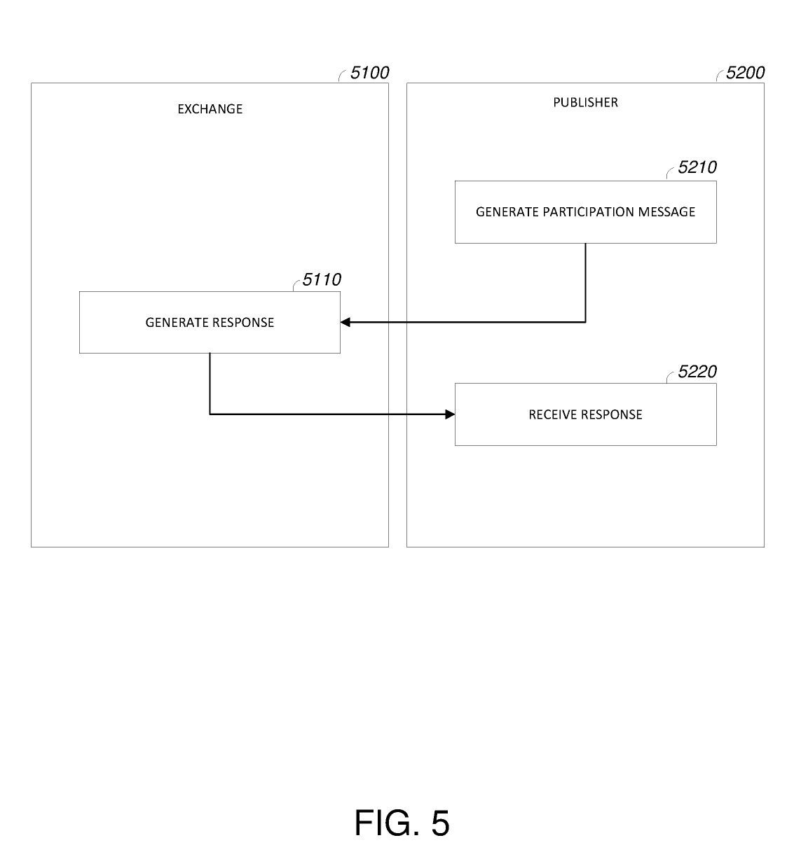

FIG. 5 is a diagram of an example of vehicle data exchange request participation messaging in accordance with embodiments of this disclosure. In some embodiments, a vehicle data exchange request participation message may include an indication that a publishing entity may participate, or publish sensor data in response to a vehicle data exchange request. In some embodiments, vehicle data exchange request participation messaging may include exchanging one or more communications between a vehicle data exchange device 5100 and a publisher device 5200, such as a vehicle, associated with a publishing entity, such as a driver, operator, or owner of the vehicle, or a personal electronic device associated with the publishing entity.

In some embodiments, exchange portions 5110 of vehicle data exchange request participation messaging may be implemented in a vehicle data exchange device 5100, which may be a communication device, such as the communication device 2400 shown in FIG. 2, and which may include one or more servers. In some embodiments, publisher portions 5210/5220 of vehicle data exchange request participation messaging may be implemented in publisher device 5200, which may be a vehicle, such as the vehicle 1000 shown in FIG. 1, or one of the vehicles 2100/2110 shown in FIG. 2, a personal electronic device, such as a smartphone, associated with the publishing entity, or a combination of a vehicle and a personal electronic device.

In some embodiments, vehicle data exchange request participation messaging may include generating a vehicle data exchange request participation message at 5210. In some embodiments, generating a vehicle data exchange request participation message may include identifying a vehicle data exchange request identifier. For example, a publisher device 5200 may receive a vehicle data exchange request discover response, as shown at 4220 in FIG. 4, which may include a vehicle data exchange request identifier, and the publisher device 5200 may identify the vehicle data exchange request identifier based on the vehicle data exchange request discover response. In another example, a publisher device 5200 may receive a vehicle data exchange request discovery notification, as shown at 11210 in FIG. 11, which may include a vehicle data exchange request identifier, and the publisher device 5200 may identify the vehicle data exchange request identifier based on the vehicle data exchange request discovery notification. In some embodiments, the publishing device 5200 may include the vehicle data exchange request identifier, an identifier of the publishing device 5200, or a combination thereof in a vehicle data exchange request participation message and may send the vehicle data exchange request participation message to a vehicle data exchange device 5100, such as the communication device 2400 shown in FIG. 2, via a network, such as the network 2300 shown in FIG. 2.

In some embodiments, the vehicle data exchange device 5100 may receive the vehicle data exchange request participation message, may generate a vehicle data exchange request participation response, and may transmit the vehicle data exchange request participation response to the publisher device 5200 at 5110.

In some embodiments, the vehicle data exchange device 5100 may store an identification of the publishing entity, or the publisher device 5200, in association with the vehicle data exchange request, may store an indication of the vehicle data exchange request in association with the publishing entity, or the publisher device 5200.

In some embodiments, generating the vehicle data exchange request participation response may include indicating whether the publisher device 5200 is a participating publishing device for the vehicle data exchange request.

In some embodiments, the vehicle data exchange device 5100 may identify a cardinality, or count, of participating publishing devices for the vehicle data exchange request, may identify a target cardinality of publishing entities for the vehicle data exchange request, a may determine whether to associate the publisher device 5200 with the vehicle data exchange request based on a difference between the cardinality of participating publishing devices and the target cardinality of publishing entities. For example, the cardinality of participating publishing devices may be within the target cardinality of publishing entities, and the publisher device 5200 may be identified as a participating publishing device and may be associated with the vehicle data exchange request. In another example, the cardinality of participating publishing devices may be equal to or greater than the target cardinality of publishing entities, and the vehicle data exchange device 5100 may identify the publisher device 5200 as a non-participating publishing device and may omit associating the publisher device 5200 with the vehicle data exchange request, or may associate the publisher device 5200 with the vehicle data exchange request as a rejected or non-participating publisher.

In some embodiments, the publisher device 5200 may receive the vehicle data exchange request participation response at 5220. In some embodiments, the vehicle data exchange request participation response may indicate that the exchange 5100 received the vehicle data exchange request participation message, or may indicate that the publisher is participating for the vehicle data exchange request.

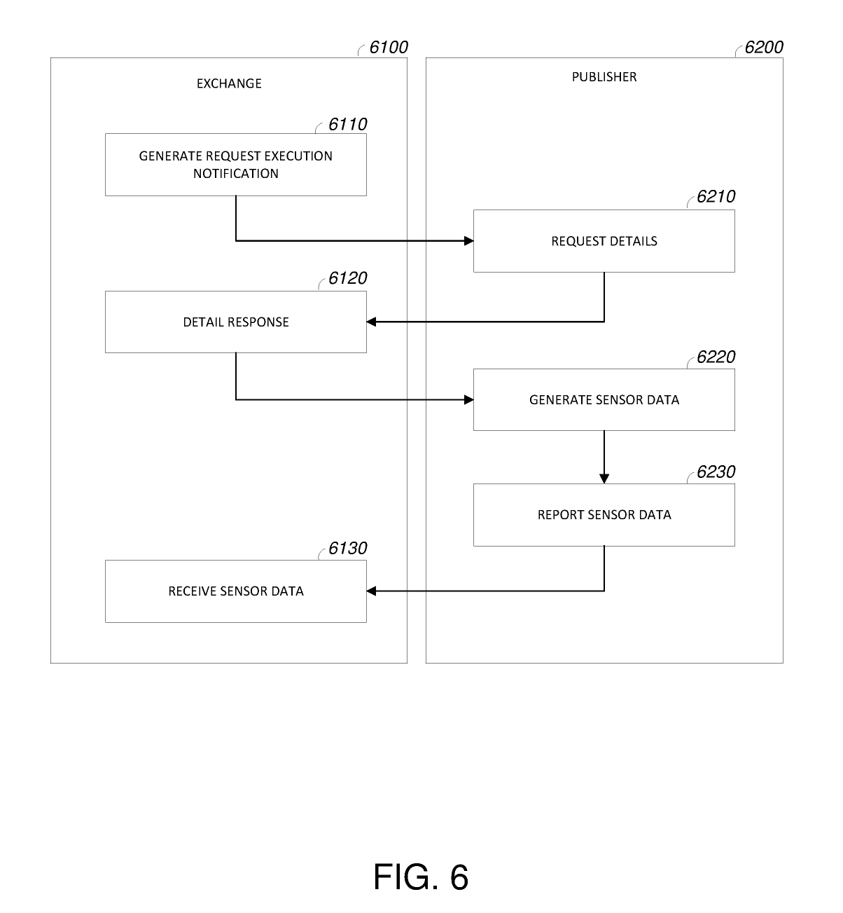

In some embodiments, vehicle data exchange request execution, as shown in FIG. 6, may be performed in response to vehicle data exchange request participation messaging as shown in FIG. 5.

FIG. 6 is a diagram of an example of vehicle data exchange request execution in accordance with embodiments of this disclosure. In some embodiments, vehicle data exchange request execution may include generating, collecting, reporting, or a combination thereof, sensor data for a vehicle data exchange request. In some embodiments, vehicle data exchange request execution may include exchanging one or more communications between a vehicle data exchange device 6100 and a publisher device 6200, such as a vehicle, associated with a publishing entity, such as a driver, operator, or owner of the vehicle, or a personal electronic device associated with the publishing entity.

In some embodiments, exchange portions 6110/6120/6130 of vehicle data exchange request execution may be implemented in a vehicle data exchange device 6100, which may be a communication device, such as the communication device 2400 shown in FIG. 2, and which may include one or more servers. In some embodiments, publisher portions 6210/6220/6230 of vehicle data exchange request execution may be implemented in a publisher device 6200, which may be a vehicle, such as the vehicle 1000 shown in FIG. 1, or one of the vehicles 2100/2110 shown in FIG. 2, a personal electronic device, such as a smartphone, associated with the publishing entity, or a combination of a vehicle and a personal electronic device. For example, a personal electronic device of a driver of the vehicle may receive sensor data from the vehicle and may report the sensor data to the exchange 6100 at 6230.

In some embodiments, vehicle data exchange request execution may include generating a vehicle data exchange request execution notification at 6110. In some embodiments, generating a vehicle data exchange request execution notification may include identifying a vehicle data exchange request. For example, a vehicle data exchange device 6100 may evaluate one or more vehicle data exchange requests to determine whether a difference between a current temporal location, such as a current time and date corresponding to the target geospatial location indicated by the vehicle data exchange request, and a temporal location, which may be within a temporal range, indicated by the vehicle data exchange request is within an active request threshold. In some embodiments, the difference between the current temporal location and the temporal location indicated by the vehicle data exchange request may be within the active request threshold and the vehicle data exchange request may be identified as an active vehicle data exchange request. In some embodiments, the difference between the current temporal location and the temporal location indicated by the vehicle data exchange request may exceed the active request threshold and the vehicle data exchange request may be identified as an inactive vehicle data exchange request. In some embodiments, vehicle data exchange requests having a vehicle data exchange request status of received or pending may be identified at 6110 and vehicle data exchange requests having a vehicle data exchange request status of reported, processed, or completed may be omitted at 6110.

In some embodiments, generating the vehicle data exchange request execution notification at 6110 may include identifying one or more participating publishers for the vehicle data exchange request. For example, a publisher may be identified as a participating publisher based on information identified as shown in FIG. 5, or automatically based on publication policy metrics indicting a push status for vehicle data exchange participation automation, as indicated at 11140 in FIG. 11.

In some embodiments, generating the vehicle data exchange request execution notification at 6110 may include identifying an active vehicle data exchange request, including the corresponding vehicle data exchange request identifier in a vehicle data exchange request execution notification, and transmitting the vehicle data exchange request execution notification to one or more participating publishers. For example, the publisher associated with the publisher device 6200 may be identified as a participating publisher and the vehicle data exchange device 6100 may transmit the vehicle data exchange request execution notification to the publisher device 6200, via a network, such as the network 2300 shown in FIG. 2. In some embodiments, the vehicle data exchange device 6100 may store the vehicle data exchange request execution notification, or information indicating the vehicle data exchange request execution notification, in a memory of the vehicle data exchange device 6100.

In some embodiments, the publisher device 6200 may receive the vehicle data exchange request execution notification and may transmit a vehicle data exchange request execution detail request to the vehicle data exchange device 6100 at 6210. In some embodiments, the publisher device 6200 may store the vehicle data exchange request execution notification, or information indicating the vehicle data exchange request execution notification, in a memory of the publisher device 6200.

In some embodiments, the vehicle data exchange device 6100 may receive the vehicle data exchange request execution detail request and may generate a vehicle data exchange request detail response at 6120. In some embodiments, a generating vehicle data exchange request detail response may include identifying one or more metrics associated with the vehicle data exchange request, such as the metrics indicated by the vehicle data exchange request, including the vehicle data exchange request metrics in the vehicle data exchange request detail response, and transmitting the vehicle data exchange request detail response to the publisher device 6200. In some embodiments, the vehicle data exchange device 6100 may store the vehicle data exchange request detail response, or information indicating the vehicle data exchange request detail response, in a memory of the vehicle data exchange device 6100. In some embodiments, the vehicle data exchange request may be associated with a vehicle data exchange request status of executing in response to transmitting the vehicle data exchange request detail response at 6120.

In some embodiments, the vehicle data exchange request execution notification generated and transmitted at 6110 may include the vehicle data exchange request metrics and transmitting the vehicle data exchange request execution detail request at 6210 and the vehicle data exchange request detail response at 6120 may be omitted.

In some embodiments, the publisher device 6200, which may be a vehicle associated with the publishing entity, may receive the vehicle data exchange request detail response and may generate or collect sensor data responsive to the vehicle data exchange request metrics indicated in the vehicle data exchange request detail response at 6220. For example, the vehicle data exchange request metrics may indicate a sensor type, and the publisher device 6200 may generate or collect sensor data using a sensor of the vehicle corresponding to the sensor type indicator. In another example, the vehicle data exchange request metrics may indicate a temporal location, and the publisher device 6200 may generate or collect sensor data at a temporal location corresponding to the temporal location indicated by the vehicle data exchange request metrics. In another example, the vehicle data exchange request metrics may indicate a geospatial location, and the publisher device 6200 may generate or collect sensor data at a geospatial location corresponding to the geospatial location indicated by the vehicle data exchange request metrics. In some embodiments, the publisher device 6200 may store the vehicle data exchange request detail response, or information indicating the vehicle data exchange request detail response, in a memory of the publisher device 6200. In some embodiments, the publisher device 6200 may store the generated or collected sensor data in a memory of the publisher device 6200.

In some embodiments, the publisher device 6200 may report sensor data at 6230. For example, the publisher device 6200 may include the sensor data generated or collected at 6220 in one or more vehicle data exchange publication messages and may transmit the vehicle data exchange publication messages to the vehicle data exchange device 6100. In some embodiments, the publisher device 6200 may generate, collect, or store sensor data independently of a vehicle data exchange request, and reporting the sensor data at 6230 may include identifying independently generated, collected, or stored sensor data corresponding to the vehicle data exchange request metrics and reporting the independently generated, collected, or stored sensor data to the vehicle data exchange device 6100 in response to the vehicle data exchange request execution notification or the vehicle data exchange request detail response. In some embodiments, the sensor data reported at 6230 may include information received from a third party, such as information indicated in an inter-vehicle message, or information generated based on information received from third parties, subject to opt-in privacy policies.

In some embodiments, the vehicle data exchange device 6100 may receive the published sensor data at 6130. In some embodiments, the vehicle data exchange device 6100 may store the received published sensor data in a memory of the vehicle data exchange device 6100. In some embodiments, the vehicle data exchange request may be associated with a vehicle data exchange request status of reported in response to receiving the published sensor data at 6130.

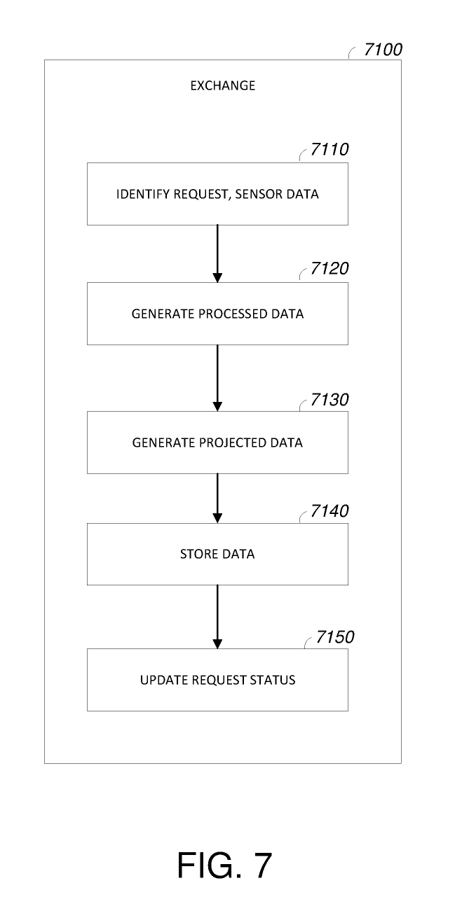

In some embodiments, sensor data processing, as shown in FIG. 7, may be performed in response to vehicle data exchange request execution as shown in FIG. 6.

FIG. 7 is a diagram of an example of sensor data processing in accordance with embodiments of this disclosure. In some embodiments, sensor data processing may include processing sensor data for a vehicle data exchange request. In some embodiments, sensor data processing may be implemented in a vehicle data exchange device 7100, which may be a communication device, such as the communication device 2400 shown in FIG. 2, and which may include one or more servers.

In some embodiments, sensor data processing may include identifying one or more vehicle data exchange requests at 7110. For example, a vehicle data exchange request created as shown in FIG. 3, may be identified at 7110. In some embodiments, identifying a vehicle data exchange request may include reading information representing the vehicle data exchange request from a memory of the vehicle data exchange device 7100. In some embodiments, identifying the vehicle data exchange request may include identifying a vehicle data exchange request status for the vehicle data exchange request. For example, the vehicle data exchange request information for the vehicle data exchange request may indicate a reported status, and the vehicle data exchange request may be identified at 7110. In another example, the vehicle data exchange request information for another vehicle data exchange request may indicate a pending status, an executing status, a processed status, or a complete status, and identifying the vehicle data exchange request at 7110 may include omitting the other vehicle data exchange request from the identified vehicle data exchange requests.

In some embodiments, sensor data processing may include identifying source sensor data corresponding to the identified vehicle data exchange request at 7110. For example, sensor data reported for a vehicle data exchange request as shown in FIG. 6 may be identified at 7110 as the source vehicle data. In some embodiments, sensor data reported independently of a vehicle data exchange request, sensor data reported for another vehicle data exchange request, or a combination thereof, may be identified at 7110 based on the vehicle data exchange request metrics indicated by the vehicle data exchange request, a publication policy associated with the publishing device corresponding to the source sensor data, or a combination thereof. In some embodiments, the vehicle source sensor data may be associated with a vehicle source sensor data state.

In some embodiments, sensor data processing may include generating processed sensor data at 7120. In some embodiments, generating processed sensor data at 7120 may include cleansing, scrubbing, validating, correcting, or otherwise omitting or repairing redundant, erroneous, or exceptional source sensor data from the processed sensor data. For example, source sensor data expressly indicating an error may be omitted from the processed sensor data. In another example, source sensor data indicating an invalid value may be omitted from the processed sensor data.

In some embodiments, sensor data processing may include generating aggregated sensor data based on the source sensor data. For example, the source sensor data may indicate a speed of a first vehicle, corresponding to a first publishing device and a first publishing entity, at a defined geospatial location, such as a lane of a vehicle transportation network; a speed of a second vehicle, corresponding to a second publishing device and a second publishing entity, at the defined geospatial location; and a speed of a third vehicle, corresponding to a third publishing device and a third publishing entity, at the defined geospatial location; and generating the aggregated sensor data may include determining an average or mean of the three speed values as an average or mean speed for the defined geospatial location. In some embodiments, the vehicle data exchange request may indicate a requested data state of sensor, or reported, and generating processed sensor data at 7120 may be omitted.

In some embodiments, sensor data processing may include generating projected data at 7130. Generating projected data may include generating extrapolated, predicted, or expected information based on reported sensor data, processed sensor data, or a combination thereof. For example, the processed sensor data generated at 7120 may indicate an average speed for a first lane of a segment of a road of a vehicle transportation network that is above a minimum value, and may indicate an average speed for a second lane of the segment of the road, adjacent to the first lane, that is below the minimum value, and generating the projected data may include generating projected data indicating that the first lane is open and generating projected data indicating that the second lane is closed. In some embodiments, the vehicle data exchange request may indicate a requested data state of reported or processed and generating projected data at 7130 may be omitted.

In some embodiments, sensor data processing may include storing processed sensor data, projected data, or both at 7140. For example, the vehicle data exchange device 7100 may store processed sensor data generated at 7120, projected data generated at 7130, or both at 7140, in a memory of the vehicle data exchange device 7100. In some embodiments, storing data at 7140 may include storing the data in association with the corresponding vehicle data exchange request.

In some embodiments, sensor data processing may include updating a status of the vehicle data exchange request at 7150. For example, the status of the vehicle data exchange request identified at 7110 may be reported, the status may be updated to processed at 7150, and the updated status may be stored, or otherwise recorded, in association with the vehicle data exchange request, such as in a memory of the vehicle data exchange device 7100, at 7150.

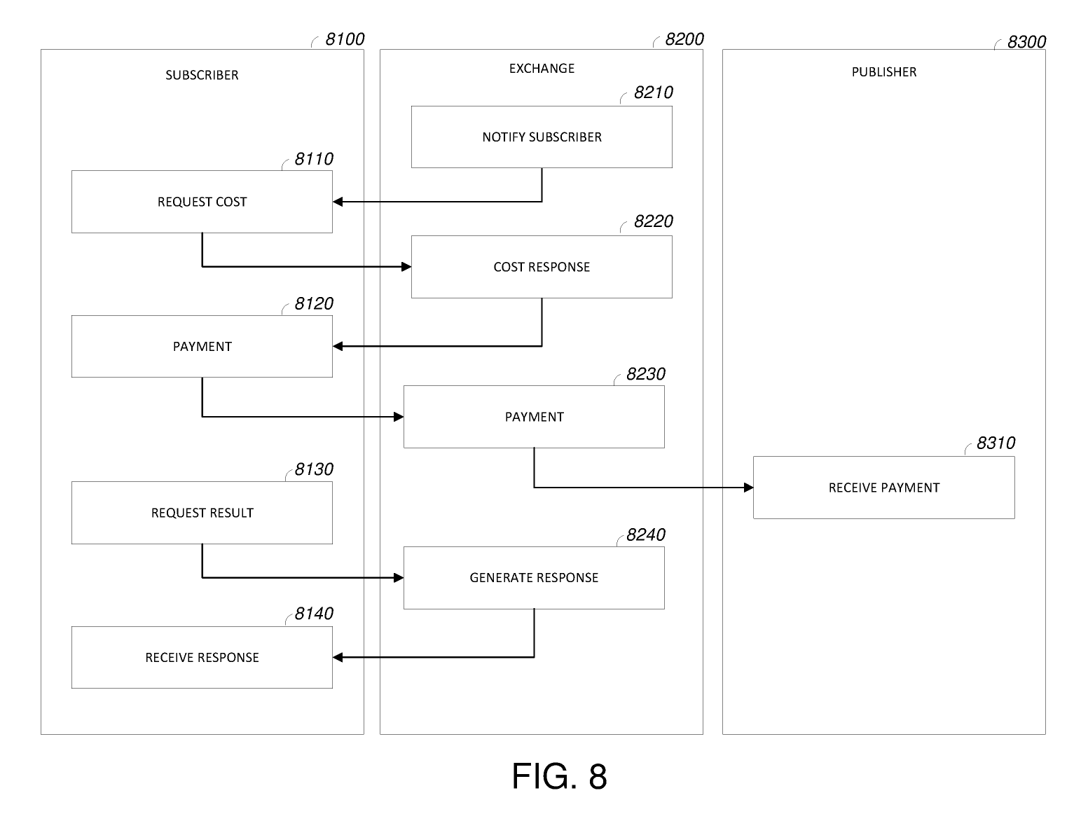

In some embodiments, completing a vehicle data exchange request, as shown in FIG. 8, may be performed in response to sensor data processing as shown in FIG. 7.

FIG. 8 is a diagram of an example of completing a vehicle data exchange request in accordance with embodiments of this disclosure. In some embodiments, completing a vehicle data exchange request may include exchanging one or more communications between a subscriber device 8100, a vehicle data exchange device 8200, and one or more publisher devices 8300. In some embodiments, subscriber portions 8110/8120/8130/8140 of completing a vehicle data exchange request may be implemented in subscriber device 8100, which may be a vehicle, such as the vehicle 1000 shown in FIG. 1, or one of the vehicles 2100/2110 shown in FIG. 2. In some embodiments, exchange portions 8210/8220/8230/8240 of completing a vehicle data exchange request may be implemented in a vehicle data exchange device 8200, which may be a communication device, such as the communication device 2400 shown in FIG. 2, and which may include one or more servers. In some embodiments, publisher portions 8310 of completing a vehicle data exchange request may be implemented in a publisher device 8300, which may be a vehicle, such as the vehicle 1000 shown in FIG. 1, or one of the vehicles 2100/2110 shown in FIG. 2. In some embodiments, publisher portions 8310 of completing a vehicle data exchange request may be implemented in a personal electronic device, such as a smartphone, associated with a driver of the vehicle.

In some embodiments, completing a vehicle data exchange request may include identifying one or more vehicle data exchange requests at 8210. For example, a vehicle data exchange request created as shown in FIG. 3, may be identified at 8210. In some embodiments, identifying a vehicle data exchange request may include reading information representing the vehicle data exchange request from a memory of the vehicle data exchange device 8200. In some embodiments, identifying the vehicle data exchange request may include identifying a vehicle data exchange request status for the vehicle data exchange request. For example, the vehicle data exchange request information for the vehicle data exchange request may indicate a reported status, the vehicle data exchange request may indicate a requested data state of reported, and the vehicle data exchange request may be identified at 8210.

In some embodiments, the vehicle data exchange request status for the vehicle data exchange request may indicate that the vehicle data exchange request is not ready for completion and completing the vehicle data exchange request may be omitted. For example, the vehicle data exchange request information for the vehicle data exchange request may indicate a reported status, the vehicle data exchange request may indicate a requested data state of processed, and the vehicle data exchange request may be omitted at 8210.

In some embodiments, completing a vehicle data exchange request may include notifying the subscriber entity, such as via the subscriber device 8100, that the vehicle data exchange request identified at 8210 is ready for completion at 8210.

In some embodiments, the subscriber device 8100 may receive a notification indicating that the vehicle data exchange request is ready for completion at 8110 and may transmit a vehicle data exchange request completion cost inquiry message to the vehicle data exchange device 8200 at 8110.

In some embodiments, the vehicle data exchange device 8200 may receive the vehicle data exchange request cost inquiry message, may generate a vehicle data exchange request cost message, which may indicate a cost for accessing the vehicle data exchange data indicated by the vehicle data exchange request, and may transmit the vehicle data exchange request cost message to the subscriber device 8100 at 8220.

In some embodiments, the subscriber device 8100 may receive the vehicle data exchange request cost message, may generate a vehicle data exchange request payment message, which may identify payment information for paying for access to the vehicle data exchange data corresponding to the vehicle data exchange request, and may transmit the vehicle data exchange request payment message to the vehicle data exchange device 8200 at 8120.

In some embodiments, the vehicle data exchange device 8200 may receive the vehicle data exchange request payment message from the subscriber device 8100, may process a payment for access to the vehicle data exchange data corresponding to the vehicle data exchange request based on the vehicle data exchange request payment information, may identify a publisher credit amount for each respective publishing entity that reported vehicle sensor data included in the vehicle data exchange data corresponding to the vehicle data exchange request, may credit each of the identified publishing entities the identified cost amount, which may be prorated based on the amount of sensor data reported by the respective publishing entity for the vehicle data exchange request, may generate a notification indicating the credit for each respective publishing entity, and may transmit the credit notification to the publisher device 8300 corresponding to the respective publishing entity, at 8230. For example, the publisher credit amount may be identified by subtracting a processing fee amount from the payment amount.

In some embodiments, processing payment information at 8230 may include updating a status of the vehicle data exchange request. For example, the status of the vehicle data exchange request may be updated to completed, and the updated status may be stored, or otherwise recorded, in association with the vehicle data exchange request, such as in a memory of the vehicle data exchange device 8200, at 8230.

In some embodiments, the publishing device 8300 may receive the credit notification at 8310.

In some embodiments, the subscriber device 8100 may generate a vehicle data exchange request result inquiry message, and may transmit the vehicle data exchange request result inquiry message to the vehicle data exchange device 8200 at 8130.

In some embodiments, the vehicle data exchange device 8200 may receive the vehicle data exchange request result inquiry message, may generate a vehicle data exchange request result message, which may include the reported data, processed data, projected data, or a combination thereof, corresponding to the vehicle data exchange request, and may transmit the vehicle data exchange request result message to the subscriber device 8100 at 8240.

In some embodiments, the subscriber device 8100 may receive the vehicle data exchange request result message at 8140.

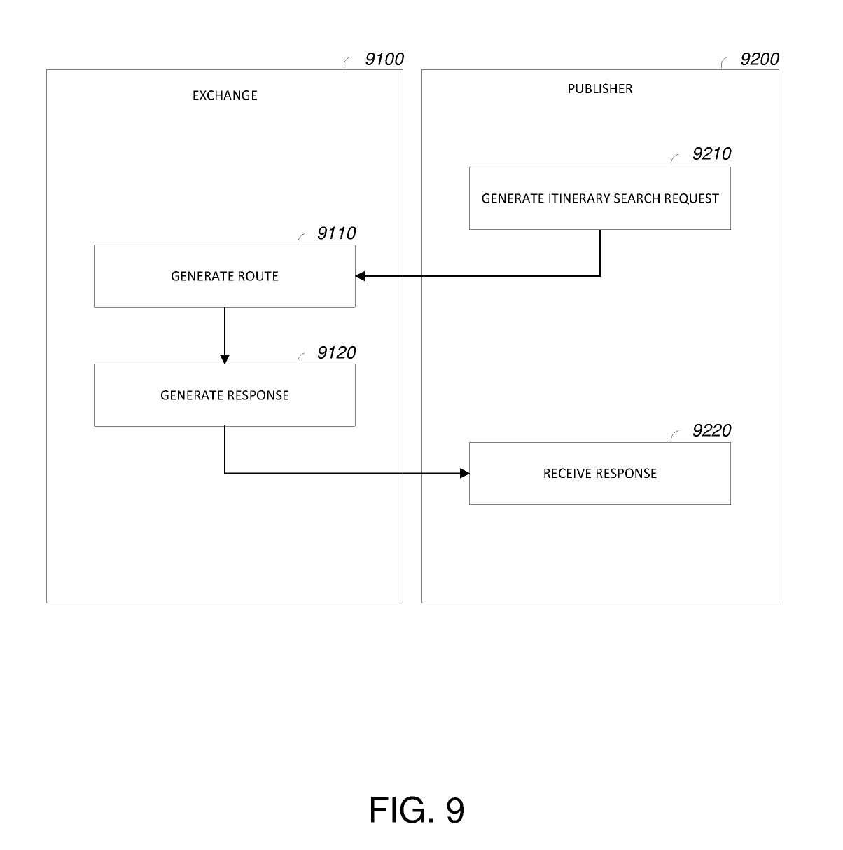

FIG. 9 is a diagram of an example of vehicle data exchange request discovery by itinerary in accordance with embodiments of this disclosure. In some embodiments, vehicle data exchange request discovery by itinerary may include exchanging one or more communications between a vehicle data exchange device 9100 and a publisher device 9200. In some embodiments, exchange portions 9110/9120 of vehicle data exchange request discovery by itinerary may be implemented in a vehicle data exchange device 9100, which may be a communication device, such as the communication device 2400 shown in FIG. 2, and which may include one or more servers. In some embodiments, publisher portions 9210/9220 of vehicle data exchange request discovery by itinerary may be implemented in a publisher device 9200, which may be a vehicle, such as the vehicle 1000 shown in FIG. 1, or one of the vehicles 2100/2110 shown in FIG. 2. In some embodiments, publisher portions 9210/9220 of vehicle data exchange request discovery by itinerary may be implemented in a personal electronic device, such as a smartphone, associated with a driver of the vehicle.

In some embodiments, vehicle data exchange request discovery by itinerary may include generating, by the publisher device 9200, a vehicle data exchange discovery by itinerary request, and transmitting the vehicle data exchange discovery by itinerary request to the vehicle data exchange device 9100 at 9210. In some embodiments, the vehicle data exchange discovery by itinerary request may include geospatial location information, such as one or more current, expected, or planned geospatial locations for the publisher vehicle. In some embodiments, the vehicle data exchange discovery by itinerary request may include temporal location information, such as an arrival time and date, a departure time and date, or both, associated with each respective geospatial location.

In some embodiments, the vehicle data exchange device 9100 may receive the vehicle data exchange discover by itinerary request and may generate an expected route for the publisher vehicle at 9110 based on the geospatial and temporal location information included in the vehicle data exchange discovery by itinerary request.

In some embodiments, the vehicle data exchange device 9100 may generate a vehicle data exchange discovery by itinerary response and may transmit the vehicle data exchange discovery by itinerary response to the publisher device 9200 at 9120. In some embodiments, generating the vehicle data exchange discovery by itinerary response may include identifying one or more vehicle data exchange requests based on the geospatial and temporal location information included in the vehicle data exchange discovery by itinerary request and based on a publisher policy corresponding to the publishing entity associated with the publisher device 9200.

For example, a vehicle data exchange requests may indicate a sensory type corresponding to a sensor type identified by the publisher policy and the vehicle data exchange request may be included in the vehicle data exchange discovery by itinerary response.

In another example, a vehicle data exchange request may indicate a geospatial location, the route generated at 9110 may omit the geospatial location indicated by the vehicle data exchange request, and the vehicle data exchange request may be omitted from the response.

In another example, a vehicle data exchange request may indicate a geospatial location and a temporal location, the route generated at 9110 may include the geospatial location at a temporal location that differs from the temporal location indicated by the vehicle data exchange request, and the vehicle data exchange request may be omitted from the response.

In another example, a vehicle data exchange request may indicate a data providence metric of unmasked, the publisher policy may indicate privacy metric of anonymous, and the vehicle data exchange request may be omitted from the response.

In some embodiments, the publisher device 9200 may receive the vehicle data exchange discover by itinerary response, including indicators of identified vehicle data exchange requests, at 9220.

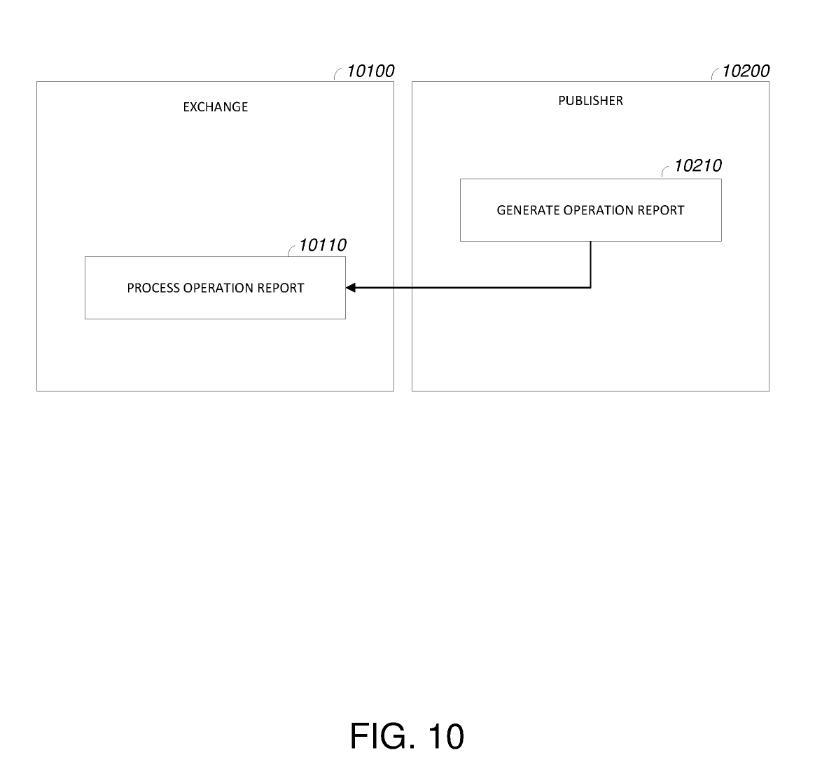

FIG. 10 is a diagram of an example of vehicle data exchange driving operation reporting in accordance with embodiments of this disclosure. In some embodiments, vehicle data exchange driving operation reporting may include exchanging one or more communications between a vehicle data exchange device 10100 and a publisher device 10200. In some embodiments, exchange portions 10210 of vehicle data exchange driving operation reporting may be implemented in a vehicle data exchange device 10200, which may be a communication device, such as the communication device 2400 shown in FIG. 2, and which may include one or more servers. In some embodiments, publisher portions 10110 of vehicle data exchange driving operation reporting may be implemented in a publisher device 10100, which may be a vehicle, such as the vehicle 1000 shown in FIG. 1, or one of the vehicles 2100/2110 shown in FIG. 2. In some embodiments, publisher portions 10110 of vehicle data exchange driving operation reporting may be implemented in a personal electronic device, such as a smartphone, associated with a driver of the vehicle.

In some embodiments, vehicle data exchange driving operation reporting may include generating, by the publisher device 10200, a vehicle data exchange operation report, and transmitting the vehicle data exchange operation report to the vehicle data exchange device 10100 at 10210. In some embodiments, the publisher vehicle may generate vehicle data exchange operation information in response to operating the vehicle, such as by traversing a portion of a vehicle transportation network. In some embodiments, the vehicle data exchange operation information may include geospatial location information, such as one or more current geospatial locations for the publisher vehicle. In some embodiments, the vehicle data exchange operation information may include temporal location information corresponding to a respective geospatial location. In some embodiments, the publisher vehicle may generate the vehicle data exchange operation information periodically, in response to defined events, or both, in response to traversing a portion of the vehicle transportation network. In some embodiments, the publisher device 10200 may generate and transmit the vehicle data exchange operation report periodically, in response to defined events, or both, in response to traversing a portion of the vehicle transportation network.

In some embodiments, the vehicle data exchange device 10100 may receive the vehicle data exchange operation report from the publisher device 10200, may process the vehicle data exchange operation information indicated in the vehicle data exchange operation report, and store the processed vehicle data exchange operation information, such as in a memory of the vehicle data exchange device 10100, at 10110. In some embodiments, processing the vehicle data exchange operation information may include identifying vehicle data exchange requests matching the vehicle data exchange operation information based on the vehicle data exchange operation information, the vehicle data exchange request, and publication policies corresponding to the publishing entity associated with the publisher device 10200.

FIG. 11 is a diagram of an example of vehicle data exchange request discovery by reported operation in accordance with embodiments of this disclosure. In some embodiments, vehicle data exchange request discovery by reported operation may include exchanging one or more communications between a vehicle data exchange device 11100 and a publisher device 11200. In some embodiments, exchange portions 11110/11120/11130/11140 of vehicle data exchange request discovery by reported operation may be implemented in a vehicle data exchange device 11100, which may be a communication device, such as the communication device 2400 shown in FIG. 2, and which may include one or more servers. In some embodiments, publisher portions 11210 of vehicle data exchange request discovery by reported operation may be implemented in a publisher device 11200, which may be a vehicle, such as the vehicle 1000 shown in FIG. 1, or one of the vehicles 2100/2110 shown in FIG. 2, a personal electronic device, such as a smartphone, associated with the publishing entity, or a combination of a vehicle and a personal electronic device.

Although not shown separately in FIG. 11, vehicle data exchange request discovery by reported operation may include identifying a vehicle data exchange request.

In some embodiments, vehicle data exchange request discovery by reported operation may include identifying one or more candidate publishers at 11110. In some embodiments, identifying candidate publishers may include identifying publishing entities for which the vehicle data exchange device 11100 has a publication policy.

In some embodiments, vehicle data exchange request discovery by reported operation may include identifying one or more amenable publishers at 11120. Identifying amenable publishers may include identifying one or more push discovery notification publishing entities, one or more push participation publishing entities, or a combination thereof, from the candidate publishers identified at 11110. A push discovery notification publishing entity may be a publishing entity having a publication policy indicating a push status for vehicle data exchange request discovery notifications for the publishing entity. A push participation publishing entity may be a publishing entity having a publication policy indicating a push status for vehicle data exchange participation automation for the publishing entity.

In some embodiments, vehicle data exchange request discovery by reported operation may include identifying one or more capable publishers at 11130. Identifying capable publishers may include evaluating respective publication policies for the amenable publishers identified at 11120, based on the vehicle data exchange request information for the identified vehicle data exchange request. For example, the vehicle data exchange request information may indicate a vehicle sensor type identifier, a corresponding vehicle sensor type identifier may be omitted from a publication policy for an amenable publisher identified at 11120, and the amenable publisher may be omitted from the capable publishers. In another example, the vehicle data exchange request information may indicate a data providence metric of unmasked, a publication policy for an amenable publisher identified at 11120 may indicate a vehicle data exchange privacy indication of masked or anonymous information, and the amenable publisher may be omitted from the capable publishers. In another example, the vehicle data exchange request information may indicate a vehicle sensor type identifier and may indicate a data providence metric of unmasked, a publication policy for an amenable publisher identified at 11120 may indicate a corresponding vehicle sensor type identifier and a vehicle data exchange privacy indication of unmasked information, and the amenable publisher may be included in the capable publishers.

In some embodiments, vehicle data exchange request discovery by reported operation may include identifying one or more expected proximal publishers at 11140. Identifying expected proximal publishers may include evaluating vehicle data exchange driving operation information, such as the vehicle data exchange driving operation information reported as shown in FIG. 10, for the capable publishers identified at 11130 to determine whether the respective vehicle data exchange driving operation information indicates geospatial information corresponding to vehicle data exchange request target geospatial information indicated in the vehicle data exchange request. In some embodiments, evaluating the vehicle data exchange driving operation information may include evaluating the vehicle data exchange driving operation information to determine whether the respective vehicle data exchange driving operation information indicates temporal information corresponding to vehicle data exchange request target temporal information indicated in the vehicle data exchange request. In some embodiments, capable publishers identified at 11130 having reported vehicle data exchange driving operation information corresponding to the vehicle data exchange request target information may be identified as expected proximal publishers at 11140.

In some embodiments, one or more of the expected proximal publishers identified at 11140 may be push participation publishing entities as indicated at 11120, and the vehicle data exchange device 11100 may store an identification of the expected proximal push participation publishing entity, or the corresponding publisher device 11200, in association with the identified vehicle data exchange request, may store an indication of the identified vehicle data exchange request in association with the expected proximal push participation publishing entity, or may store both an identification of the expected proximal push participation publishing entity in association with the identified vehicle data exchange request and an indication of the identified vehicle data exchange request in association with the expected proximal push participation publishing entity, which may indicate that the corresponding publishing entity is a participating publishing entity for the identified vehicle data exchange request.

In some embodiments, vehicle data exchange request execution, as shown in FIG. 6, may be performed in response to storing the information indicating that the corresponding publishing entity is a participating publishing entity for the identified vehicle data exchange request at 11140.

In some embodiments, one or more of the expected proximal publishers identified at 11140 may be pull participation publishing entities and may be push discovery notification publishing entities as indicated at 11120, the vehicle data exchange device 11100 may generate a vehicle data exchange request notification indicating the identified vehicle data exchange request, and may transmit the vehicle data exchange request notification to each expected proximal pull participation publishing entity, or corresponding publisher devices, from the expected proximal publishing entities.

In some embodiments, the publisher device 11200, may receive the vehicle data exchange request notification at 11210. In some embodiments, the publisher device 11200 may store the vehicle data exchange request notification, or information indicated therein, in a memory of the publisher device 11200.

The above-described aspects, examples, and implementations have been described in order to allow easy understanding of the disclosure are not limiting. On the contrary, the disclosure covers various modifications and equivalent arrangements included within the scope of the appended claims, which scope is to be accorded the broadest interpretation so as to encompass all such modifications and equivalent structure as is permitted under the law.

What is claimed is:

1. A method comprising:
receiving, from a subscriber device associated with a subscribing entity, a vehicle data exchange request including a vehicle sensor type identifier and vehicle data exchange request target information, wherein the vehicle data exchange request target information includes an indication of a defined geospatial region;
identifying, based on the vehicle data exchange request, a publishing entity;
transmitting a vehicle data exchange request execution notification to a publisher device associated with the publishing entity;
receiving, from the publisher device, vehicle sensor data generated by a sensor of a vehicle associated with the publishing entity within the defined geospatial region;
generating a vehicle data exchange response based on the vehicle sensor data; and
transmitting the vehicle data exchange response to the subscriber device.

2. The method of claim 1, wherein the vehicle data exchange request includes:
a target cardinality of publishing entities.

3. The method of claim 1, wherein the vehicle data exchange request target information includes the defined geospatial region and a defined temporal region.

4. The method of claim 1, wherein the vehicle data exchange request includes:
the vehicle sensor type identifier;
a data state identifier;
a data providence metric;
an incentive indication; and
the vehicle data exchange request target information.

5. The method of claim 4, wherein the data state identifier indicates one of a source data state, a processed data state, or a projected data state.

6. The method of claim 4, wherein the data providence metric indicates one of anonymous, masked, or unmasked.

7. The method of claim 4, wherein the incentive indication indicates a fixed value incentive.

8. The method of claim 1, wherein receiving the vehicle data exchange request includes:
identifying a request identifier for the vehicle data exchange request; and
transmitting the request identifier to the subscriber device.

9. The method of claim 8, wherein transmitting the vehicle data exchange request execution notification to the publisher device includes transmitting the request identifier to the publisher device.

10. The method of claim 1, wherein identifying the publishing entity includes:
identifying candidate publishing entities, wherein the candidate publishing entities include the publishing entity;
identifying amenable publishing entities from the candidate publishing entities, wherein the amenable publishing entities include the publishing entity;
identifying capable publishing entities from the amenable publishing entities, wherein the capable publishing entities include the publishing entity;
identifying expected proximal publishing entities from the capable publishing entities, wherein the expected proximal publishing entities include the publishing entity, and wherein each expected proximal publishing entity from the expected proximal publishing entities is a push participation publishing entity or a pull participation publishing entity; and
transmitting a vehicle data exchange request notification indicating the vehicle data exchange request to each pull participation publishing entity from the expected proximal publishing entities.

11. The method of claim 1, wherein identifying the publishing entity includes:
receiving, from the publisher device, a vehicle data exchange request discovery message, the vehicle data exchange request discovery message including a publication metric, wherein the vehicle data exchange request satisfies the publication metric.

12. The method of claim 1, wherein identifying the publishing entity includes:
receiving, from the publisher device, publication policy information, wherein the publication policy information includes one or more of:
an available vehicle sensor identifier;
vehicle data exchange privacy information;
vehicle data exchange request discovery notification information;
vehicle data exchange participation automation information;
vehicle data exchange participation incentive information;
vehicle data exchange operation publication information; or
vehicle data exchange publication mode information.

13. The method of claim 1, wherein identifying the publishing entity includes:
receiving, from the publisher device, expected location information indicating an expected geospatial location for the vehicle, wherein route information, based on the expected location information, indicates that at least a portion of an expected route for the vehicle to traverse a vehicle transportation network intersects with the defined geospatial region.

14. The method of claim 1, wherein generating the vehicle data exchange response includes:
on a condition that the vehicle data exchange request indicates a source data state, including at least a portion of the vehicle sensor data in the vehicle data exchange response;
on a condition that the vehicle data exchange request indicates a processed data state, generating processed data based on the vehicle sensor data, and including at least a portion of the processed data in the vehicle data exchange response; and
on a condition that the vehicle data exchange request indicates a projected data state, generating projected data based on the vehicle sensor data, and including at least a portion of the projected data in the vehicle data exchange response.

15. The method of claim 1, wherein transmitting the vehicle data exchange response to the subscriber device includes:
transmitting an available vehicle data exchange response notification to the subscriber device;
in response to receiving, from the subscriber device, a vehicle data exchange response cost request, transmitting a vehicle data exchange response cost notification to the subscriber device;
receiving, from the subscriber device, vehicle data exchange response cost satisfaction information; and
receiving, from the subscriber device, a vehicle data exchange response detail request, transmitting.

16. The method of claim 1, wherein on a condition that the vehicle data exchange request indicates a requested temporal location preceding a current temporal location, omitting transmitting the vehicle data exchange request execution notification.

17. A method comprising:
transmitting, from a subscriber device associated with a subscribing entity, to a vehicle data exchange device, a vehicle data exchange request including a vehicle sensor type identifier and vehicle data exchange request target information, wherein the vehicle data exchange request target information includes an indication of a defined geospatial region; and
receiving a vehicle data exchange response from the vehicle data exchange device, wherein the vehicle data exchange response includes:
information based on vehicle sensor data generated by a sensor of a vehicle in the defined geospatial region, wherein the vehicle is associated with a publishing entity identified by the vehicle data exchange device based on the vehicle data exchange request.

18. The method of claim 1, wherein the vehicle data exchange request includes:
the vehicle sensor type identifier;
a target cardinality of publishing entities;
a data state identifier, wherein the data state identifier indicates one of a source data state, a processed data state, or a projected data state;
a data providence metric, wherein the data providence metric indicates one of anonymous, masked, or unmasked;
an incentive indication, wherein the incentive indication indicates a fixed value incentive;
a recurrence metric; and
the vehicle data exchange request target information.

19. A method comprising:
transmitting, by a publisher device associated with a publishing entity, to a vehicle data exchange device, publication policy information;
on a condition that the publication policy information indicates a vehicle data exchange request discovery notification push status, receiving a vehicle data exchange request notification from the vehicle data exchange device;
in response to receiving the vehicle data exchange request notification, and on a condition that the publication policy information indicates a vehicle data exchange participation automation pull status, transmitting, to the vehicle data exchange device, a vehicle data exchange request participation message;
in response to transmitting the vehicle data exchange request participation message or on the condition that the publication policy information indicates the vehicle data exchange participation automation pull status, receiving, by the publisher device, from the vehicle data exchange device, a vehicle data exchange request execution notification based on a vehicle data exchange request, the vehicle data exchange request received by the vehicle data exchange device from a subscriber device associated with a subscribing entity, the vehicle data exchange request including a vehicle sensor type identifier and vehicle data exchange request target information, wherein the vehicle sensor type identifier corresponds with a sensor of a vehicle associated with the publishing entity, and wherein the vehicle data exchange request target information includes an indication of a defined geospatial region;
traversing, by the vehicle, a portion of a vehicle transportation network, wherein traversing includes generating vehicle sensor data by the vehicle sensor within the defined geospatial region; and
transmitting, to the vehicle data exchange device, the vehicle sensor data.

20. The method of claim 1, wherein the publication policy information includes at least one of:
an available vehicle sensor identifier;
vehicle data exchange privacy information;
vehicle data exchange request discovery notification information;
vehicle data exchange participation automation information;
vehicle data exchange participation incentive information;
vehicle data exchange operation publication information; or
vehicle data exchange publication mode information.
